(19) United States
(12) Patent Application Publication
(10) Pub. No.: US 2025/0046945 A1
(43) Pub. Date: Feb. 6, 2025

(54) Method For Constructing Exhaust Channel For Power Box And Power Box

(71) Applicant: L'OS INTERNATIONAL ELECTRIC CO., LTD., Jiangmen City (CN)

(72) Inventor: Fanchang ZENG, Jiangmen City (CN)

(21) Appl. No.: 18/810,799

(22) Filed: Aug. 21, 2024

Related U.S. Application Data
(63) Continuation of application No. PCT/CN2024/107699, filed on Jul. 26, 2024.

(30) Foreign Application Priority Data
Aug. 2, 2023 (CN) 202310970057.3

(51) Int. Cl. H01M 50/30; B01D 46/00; B01D 46/24; H01M 10/12; H01M 50/367

(52) U.S. Cl. CPC H01M 50/394; B01D 46/0001; B01D 46/0005; B01D 46/2403; H01M 10/12; H01M 50/367; B01D 2279/45

(57) ABSTRACT

The present disclosure relates to the field of power supply devices, and in the present disclosure, a method for constructing an exhaust channel for a power box and a power box are provided, where the method includes: S1, providing a closed box body: S2, providing an opening portion on the box body; and S3, fixing a porous filter to the opening portion through a fastening member, and enclosing the opening portion. In this way, the watertightness of the box body is improved while the ventilation of the box body is maintained, and an emergency power box with high explosion-proof performance is produced.

### CROSS REFERENCE

The present application is a continuation-application of International (PCT) Patent Application No. PCT/CN2024/107699, filed on Jul. 26, 2024, which aims priority of Chinese Patent Applications No. 202310970057.3 filed on Aug. 2, 2023, the entire contents of which are hereby incorporated by reference in their entirety.

### TECHNICAL FIELD

The present disclosure relates to the field of power supply devices, and in particular, relates to a method for constructing an exhaust channel in a power box.

### BACKGROUND

An emergency power box may be a box for storing electronic devices such as circuit boards and emergency power supplies of an emergency evacuation indication system to control emergency lamps in public buildings, etc. When the emergency power box adopts a battery assembly for powering, if there is a mains power supply, the emergency power box is powered by a switch power supply, and after the mains power supply stops, the emergency power box is powered by the battery assembly, to ensure lighting and indication of emergency evacuation or firefighting operations.

An explosion-proof emergency power box can be used in dangerous places where combustible gases and dust exist, which can prevent arcs, sparks and high temperatures that may be generated in a lamp from igniting the combustible gases and dust in the surrounding environment, thereby meeting an explosion-proof requirement.

In the prior art, some emergency power boxes, such as fire emergency centralized power supplies, use lead-acid batteries as emergency power supplies. During a charging process of the lead-acid battery, a positive electrode in the battery releases oxygen and a negative electrode releases hydrogen. This is because when charging, a current passes through sulfuric acid in an electrolyte chamber, so that Pb02 (lead dioxide) on the positive electrode and Pb (lead) on the negative electrode react chemically, thereby generating gases. These gases need to be discharged out of the battery through the exhaust vent, otherwise the internal pressure of the battery will be too high, and even the battery will explode. This explosion in the power box is even more unacceptable for the external dangerous environment. Therefore, in national standards in the explosion-proof field, gas concentrations in devices are strictly limited.

Therefore, existing explosion-proof emergency power boxes are relatively low in waterproof level, for example, can only meet ingress protection standards of IP23. The main reason is that improvement of the waterproof level is to improve the tightness of the whole device. But after the tightness is improved, the gases discharged by the lead-acid battery cannot be discharged out of the emergency power box, which cannot meet national explosion-proof standards, and is prone to explosion. However, if the overall tightness of the box body is not improved, it is not conducive to the waterproof and dustproof performance of the power box, and some electric sparks and high temperatures in the power box are also easy to penetrate the box body and cause an explosion in the external environment.7

In the prior art, the power box is lack of a centralized exhaust channel, and gases discharged by the battery is allowed to diffuse everywhere in the box body and escape to the outside of the box body via some gaps at corners of the box body.

Therefore, in the prior art, a method for constructing an exhaust channel in a power box is urgently needed, and an exhaust channel with explosion resistance and high waterproofness can be constructed in the power box.

### SUMMARY

In view of the above defects, one of the objectives of the present disclosure is to provide a power box having both tightness and gas permeability.

At least to solve the above technical problem, in an embodiment of the present application, provided is a method for constructing an exhaust channel for a power box, including the steps:
S1, providing a closed box body;
S2, providing an opening portion on the box body; and
S3, fixing a porous filter (or, also referred to as: a filter) to the opening portion through a fastening member, and enclosing the portion.

Optionally, in some embodiments, at least one battery assembly is accommodated in the power box, and is capable of discharging gases; and the method further includes the step:
S4, constructing a fluid channel between the inside of the battery assembly and the opening portion.

Optionally, in some embodiments, the step S4 further includes the steps:
S41, covering an exhaust port of the at least one battery assembly or an exhaust groove where the exhaust port is located through a gas collection cover;
S42, hermetically connecting the gas collection cover with the periphery of a notch of the exhaust groove or the exhaust port; and
S43, constructing a first section of the fluid channel between the opening portion and an exhaust vent/the exhaust port.

Optionally, in some embodiments, the step S43 further includes the steps:
S431, enabling fluid communication between a) the opening portion and b) the exhaust vent/the exhaust port through an exhaust pipe;
S432, using a) a pipe fastener that fits a first end of the exhaust pipe and/or b) a hollow gas release member that fits a second end of the exhaust pipe to fix the exhaust pipe; and
S433, constructing a second section of the fluid channel between a gas outlet of the second end of the exhaust pipe and the opening portion.

Optionally, in some embodiments, the step S433 further includes the steps:
S4331, inserting the second end of the exhaust pipe into a hollow chamber of the gas release member, thereby enabling the gas outlet to be in fluid communication with the porous filter or a surface of the porous filter through a gas release port of the gas release member;
S4332, shaping the porous filter into a hollow cylinder/hollow column, and fitting the porous filter with at least a portion of the gas release member in a sleeving manner;
S4333, protruding the opening portion corresponding to the porous filter to the outside of the box body and shaping into any of the following: a circular cylinder, a hollow cylinder, a cavity, a tubular cavity, or a finger ring shape; and
S4334, fixing the porous filter to the opening portion through a fastening member, and hermetically engaging the porous filter with the opening portion, so that the fastening member cooperates with the porous filter to enclose the opening portion.

Optionally, in some embodiments, the fastening member includes a fixing cover, the porous filter is provided with a first port and a second port, and the first port and the second port are in communication through the inside of the porous filter; and the step S4333 further includes the step:
closing the second port of the porous filter through the fixing cover, and pressing and fixing the first port on an open end face of the opening portion to hermetically connect the opening portion; and the method further includes the steps:
S5, arranging a sealing member at one or more of the following places: a) between the filter and the fastening member, or b) between the filter and the opening portion, or c) between the fixing cover and the second port; or d) between an inner side of the opening portion and the gas collection cover; or e) between the opening portion and the gas release member; or f) between an inner wall of the opening portion and an outer pipe wall of the exhaust pipe; or g) between the first end of the exhaust pipe and the exhaust vent; and h) between the first end of the exhaust pipe and the pipe fastener;
S6, enabling a plurality of opposite walls of the box body to be concave inward to abut against/approach the battery assembly, where the opposite walls include: i) a top wall, a bottom wall and/or ii) opposite side walls; and
S7, shaping the porous filter such that a maximum pore diameter/average pore diameter of the porous filter is within any of the following intervals: [0.01 microns, 300 microns], [0.1 microns, 1.5 microns], [0.01 microns, 1 micron], [1 micron, 100 microns], [150 microns, 200 microns] or [100 microns, 180 microns], [0.05 microns, 150 microns], or [0.01 microns, 200 microns], where
the enclosing is watertight covering or watertight enclosing;
the sealing member is an elastic member, the sealing member is made of an elastomer material, and the sealing member is shaped into a gasket, a washer, or an O-ring;
the hermetical engagement is gas-tight coupling, and the gas-tight coupling is a gas-tight and liquid-tight threaded connection or chemical bounding; or
the engagement is a hermetical engagement, the hermetical engagement is a hermetical connection/hermetical sleeve fitting/hermetical sleeve connection and has liquid tightness and/or gas tightness, and the hermetical engagement includes a threaded connection; or the engagement has fluid communication;
the communication is fluid communication and/or hermetical communication;
the fluid communication is gas communication;
the gas inlet is in hermetical communication with the exhaust vent, and the filter closes the gas outlet, thereby forming the fluid channel, which provides a fluid-tight channel or a gas-tight channel between the exhaust vent and the filter, and provides a fluid channel by using the filter, which is in gas communication but not in liquid communication, between the inside and outside of the box body;
the watertightness of the filter is stronger than the gas tightness; the filter has gas permeability, and the filter does not have water permeability under the same temperature and/or pressure conditions;
the box body has a closed/sealed structure except the filter, or maintains watertightness and gas tightness; the filter has watertightness and no gas tightness; and
one or more of the batteries are lead-acid batteries that are capable of discharging gases.

Another objective of the present disclosure is to improve the waterproofness and gas permeability of a power box.

At least to solve one of the above technical problems, in an embodiment of the present application, provided is a power box having a new structure, including:
a box body;
an opening portion, penetrating through a box wall of the box body;
a battery assembly, accommodated in the box body;
a porous filter, encapsulating the opening portion; and
a fastener,
where the porous filter is mounted to the opening portion through the fastener, and a maximum pore diameter/average pore diameter of the porous filter is within the following interval: [0.01 microns, 300 microns].

Optionally, in some embodiments, the fastener includes a fastening member or a chemical bonding layer, where
the fastening member cooperates with the porous filter to enclose the opening portion; and
a maximum pore diameter/average pore diameter of the porous filter is within any of the following intervals: [0.1 microns, 1.5 microns], [0.01 microns, 1 micron], [1 micron, 100 microns], [150 microns, 200 microns] or [100 microns, 180 microns], [0.05 microns, 150 microns], or [0.01 microns, 250 microns].

Optionally, in the power box of some embodiments, the porous filter is fixed on the box body through a fastening member, and covers/encloses the opening portion.

Optionally, in the power box of some embodiment, the fastening member further includes a press fixing member and/or a connector, where the press fixing member presses and fixes the porous filter on the box body; or the connector is connected to the press fixing member and the box body; and the porous filter is clamped and fixed between the press fixing member and the box body.

Optionally, the power box of some embodiments further includes a fastening member.

The filter is fixed on the box body through the fastening member, and covers/encloses the opening portion.

Optionally, in the power box of some embodiments, the fastening member further includes a press fixing member and/or a connector, where the press fixing member presses and fixes the filter on the box body; or the connector is connected to the press fixing member and the box body; and the filter is clamped and fixed between the press fixing member and the box body.

Optionally, in the power box of some embodiments, the filter includes a filter element, where the filter element has a porous structure or is made of a porous material.

Optionally, in the power box of some embodiments, the filter corresponds to and/or fits the opening portion, and the filter is suitable for being engaged with the opening portion.

Optionally, in the power box of some embodiments, the filter is shaped into a cover body, and the filter fits the shape of the opening portion; and

The filter has a hollows structure, and the filter is shaped into any of the following: a circular cylinder, a hollow cylinder, a cavity, a tubular cavity, or a finger ring shape; or the filter is provided with a first port, and the first port is connected to the opening portion.

Optionally, in the power box of some embodiments, a second positioning portion is arranged along the circumference of the opening portion, and the second positioning portion fits/corresponds to the first port; the first port is relatively fixed and/or connected to the opening portion through the second positioning portion; and/or
the filter is further provided with a second port opposite to the first port. The first port and the second port are in mutual communication through the inside of the filter; the fixing cover is pressed and fixed on the second port and closes the port; a first positioning portion is arranged on the periphery of an inner side of the fixing cover, and the first positioning portion fits/corresponds to the second port; and the fixing cover is relatively fixed to the second port through the first positioning portion, and closes the second port.

Optionally, in the power box of some embodiments, the first positioning portion is a groove or a step position, the first positioning portion is arranged on the inner side of the fixing cover along the circumference direction, and the first positioning portion clamps and fixes the second port; and/or
the second positioning portion is a groove or a step position, the second positioning portion is arranged along an end face of the opening portion, and the second positioning portion clamps and fixes the first port.

Optionally, the power box of some embodiments further includes a gas release member, where the gas release member has a hollow structure, and the gas release member is provided with a gas vent and a mounting port;
the inside of the gas release member is in communication with the outside through the gas vent; or the gas vent and the mounting port are in fluid communication through the inside of the gas release member; the mounting port is engaged with the opening portion, and the mounting port is in fluid communication with the filter or an inner surface thereof through the inside of the gas release member and the gas vent.

Optionally, in the power box of some embodiments, the opening portion is shaped to protrude to the outside of the box body; the mounting port is provided in a first end of the gas release member, and the first end of the gas release member is in threaded connection with the opening portion;
the gas vent is provided in a second end of the gas release member, the member is i) in fluid communication with the outside of the opening portion, or ii) exposed to the outside of the opening portion; the press fixing member includes a fixing cover, and the connector is a screw; the fixing cover presses and fixes the filter to the opening portion; the screw passes through the fixing cover, and is in threaded connection with the second end of the gas release member.

Optionally, the power box of some embodiments further includes an exhaust pipe, where the exhaust pipe is in fluid communication with the exhaust vent and the gas release member, or the exhaust pipe is in fluid communication with the inside of the battery assembly and the gas release member;
a first end and a second end of the exhaust pipe separately define a gas inlet and a gas outlet; the battery assembly is provided with an exhaust vent; the gas inlet is in communication with the exhaust vent; the mounting port is sleeved at the second end of the exhaust pipe, and the gas outlet is in fluid communication with the gas vent; or the second end of the exhaust pipe is inserted into the gas release member from the mounting port, and the gas outlet is in fluid communication with the gas vent through the inside of the gas release member.

Optionally, in the power box of some embodiments, A) the battery assembly further includes a housing, and the exhaust vent is provided in the housing; or B) the battery assembly further includes a housing, a gas collection cover, and one or more lead-acid batteries, where each lead-acid battery is provided with an exhaust port; the housing is partially concave to form an exhaust groove, and the exhaust vents in the one or more lead-acid batteries are all located in the exhaust groove; the gas collection cover covers the exhaust groove, the gas collection cover is connected/hermetically connected to a notch of the exhaust groove, and the exhaust vent is provided in the gas release cover.

Optionally, in the power box of some embodiments, the first end of the gas release member extends from the opening portion into the box body, and the first end of the gas release member is engaged with the second end of the exhaust pipe; the second end/gas vent of the gas release member is exposed to the outside of the opening portion;
the exhaust pipe is a flexible pipe, and the exhaust pipe is in flexible communication with the exhaust vent and the mounting port; and the first end of the exhaust pipe is engaged with the exhaust vent.

Optionally, the power box of some embodiments further includes a sealing member, where the scaling member is arranged between the opening portion and the gas release member;
the first end of the gas release member extends along the inner wall of the opening portion to the periphery of the opening portion, and an extended portion of the first end of the gas release member is clamped and fixed on the inner side of the opening portion through the sealing member.

Optionally, in the power box of some embodiments, the second end of the gas release member is integrally connected to the middle portion of the inner side of the fixing cover, the second end of the gas release member is perpendicular to the fixing cover, the second end of the gas release member extends to the opening portion, the first end of the gas release member is in connection/sleeve connection/sleeve fitting/threaded connection with the opening portion; the first end of the gas release member extends into the opening portion/the box body, and the mounting port is aligned with or in fluid communication with the exhaust vent;
a protruding space of the opening portion is filled with a sealing member, the sealing member is located a) between the inner side of the opening portion and the gas collection cover; or b) between the inner side of the opening portion and the housing, and the sealing member surrounds i) the opening portion and ii) the exhaust vent.

Optionally, the power box of some embodiments further includes a scaling member, where the scaling member is filled in the opening portion, and the sealing member is located between a) the inner wall of the opening portion and b) the outer pipe wall of the exhaust pipe.

Optionally, in the power box of some embodiments, the first end of the exhaust pipe is fixed to the gas collection cover or the housing by welding or chemical bounding, and the gas inlet of the exhaust pipe is in communication/hermetical communication with the exhaust vent.

Optionally, the power box of some embodiments further includes: a fixing connector and a sealing member, where
the first end of the exhaust pipe extends into the box body, and the first end of the exhaust pipe is engaged with the exhaust vent through the fixing connector; and
the sealing member is arranged between the first end of the exhaust pipe and the exhaust vent, and the sealing member surrounds the exhaust vent.

Optionally, in the power box of some embodiments, the fixing connector further includes:
a fixing member, where the fixing member is provided with a through hole, the fixing member is in fluid communication with and engaged with the exhaust vent; the fixing member is fixed on the gas collection cover or the housing; and
a pipe fastener, where the pipe fastener is separately connected to the fixing member and the first end of the exhaust pipe; the first end of the exhaust pipe and the fixing member clamp and fix the scaling member; the sealing member surrounds the through hole; and the gas inlet is in fluid communication with the through hole.

Optionally, in the power box of some embodiments, the pipe fastener is provided with a first opening and a second opening opposite to each other, where the first opening fits the fixing member in a sleeving manner, the second opening fits the first end of the exhaust pipe in a sleeving manner, the pipe fastener fastens and connects the fixing member with the first end of the exhaust pipe through the first opening and the second opening; and the first opening and the second opening are in communication through the inside of the pipe fastener.

Optionally, in the power box of some embodiments, the first end of the exhaust pipe extends into the second opening; the second opening is contracted inward, or the first end of the exhaust pipe extends outward/to the periphery along the transverse direction, to be clamped into the second opening; and
the pipe fastener is in threaded connection with the fixing member, and the pipe fastener extrudes the first end of the exhaust pipe to the fixing member through the second opening.

Optionally, the power box of some embodiments further includes a fluid channel, where the fluid channel is in communication with the inside of the battery assembly and the opening portion;
the covering/enclosing is watertight covering or watertight enclosing; an engaged portion/joint portion between a porous body and the fastening member, and an engaged portion/joint portion between the porous body and the opening portion have watertightness and/or gas tightness and/or tightness. Or the engaged portion/joint portion between the filter and the fastening member and the engaged portion/joint portion between the filter and the opening portion have watertightness and/or gas tightness and/or tightness.

The screw passes through the fixing cover from the outside of the box body, the screw extends toward the opening portion, and the screw is in threaded connection with a screw hole in the gas release member,
the sealing member is an elastic member, the scaling member is made of an elastomer material, and the sealing member is shaped into a gasket, a washer, or an O-ring;
the sealing member is filled in the opening portion, and the sealing member is located between two or three of: a) the inner wall of the opening portion, b) the outer pipe wall of the exhaust pipe, and c) the second end of the exhaust pipe.

Optionally, the porous body is a filter that may be implemented a porous filter element.

The gas collection cover hermetically covers the exhaust port, and a sealant is filled between the gas collection cover and the housing covered by the gas collection cover;
the hermetical engagement is gas-tight coupling, and the gas-tight coupling is a gas-tight and liquid-tight threaded connection or chemical bounding; or
the engagement is a hermetical engagement, the hermetical engagement is a hermetical connection/hermetical sleeve fitting/hermetical sleeve connection, the hermetical engagement has liquid tightness and/or gas tightness, and the hermetical engagement includes a threaded connection; or the engagement has fluid communication; the communication is fluid communication and/or hermetical communication; and the fluid communication is gas communication. For example, fluid communication between a component A and a component B means that the insides of the two can maintain a fluid connection, or a fluid can flow from A to B. Hermetical communication between a component A and a component B means that an engaged portion/joint portion between A and B is scaled/closed, and a fluid cannot flow out through the engaged portion/joint portion.

The gas inlet is in hermetical communication with the exhaust vent, and the filter closes the gas outlet, thereby forming the fluid channel, which provides a fluid-tight channel or a gas-tight channel between the exhaust vent and the filter, and provides a fluid channel by using the filter, which is in gas communication but not in liquid communication, between the inside and outside of the box body;
the watertightness of the filter is stronger than the gas tightness; the filter has gas permeability, and the filter does not have water permeability under the same temperature and/or pressure conditions; the box body has a closed/scaled structure except the filter, or maintains watertightness and gas tightness; the filter has watertightness and no gas tightness; the transverse direction is perpendicular to the axial direction/length direction/extension direction of the exhaust pipe; and a plurality of opposite walls of the box body are concave inward to abut against/approach the battery assembly, where the opposite walls include: i) a top wall, a bottom wall, and/or ii) opposite side walls.

In addition, the expression “the box body has a closed/sealed structure except the filter” here means that all portions of the box body have sealing performance and ability except the filter, rather than always maintaining a scaled state. For example, other large-sized openings may be provided in the box body and corresponding scaling covers may be arranged on the box body to facilitate manual operations such as maintenance and repair operations inside the box body. However, the opening and the sealing cover have a sealing ability. Once the sealing cover is closed on the opening, both water and gas cannot penetrate the box body through an engaged portion/joint portion between the scaling cover and the opening.

As an important safety facility, an emergency lamp is powered by a main machine connected thereto, where the main machine is an emergency lighting controller, or an emergency power box, or an emergency distribution box; the change of output power of the main machine may lead to flickering effects of electrical appliances, which will be unfavorable to fire emergency lighting.

To solve this problem, in some embodiments of the present application, an energy storage is connected to the inside of the main machine or a light source board of a fire emergency lighting lamp powered by the main machine as a buffer unit for electrical energy, so that a power supply to the light source board in the fire emergency lighting lamp can be kept stable during fluctuation of the power supply provided by the main machine, and therefore, luminous power of the light source board is basically constant.

Accordingly, the emergency lighting controller, an emergency lighting centralized power supply, an emergency lighting distribution unit or an emergency lighting distribution box in some embodiments of the present application each further include the above energy storage. An emergency power box of any embodiment of the present application may further include: a power supply board and an energy storage, where the energy storage is arranged on the power supply board, electrically connected to the power supply board, and is used to connect electrical energy from the battery assembly; the energy storage further includes:
a plurality of power storage assemblies, and the plurality of power storage assemblies each include an anode and a cathode;
a second power storage assembly; and
one or more switching units, where the one or more switching units each include two or more poles, where
in a high-level mode of the one or more switching units, the first power storage assembly and the second power storage assembly are coupled in series, and
in a low-level mode of the one or more switching units, the first power storage assembly and the second power storage assembly are coupled in parallel.

Optionally, in an embodiment of the present application:
the one or more switching units each include a first single-pole double-throw switch and a second single-pole double-throw switch;
in the high-level mode, both the first single-pole double-throw switch and the second single-pole double-throw switch are in a first switch position, thereby connecting the anode of the first power storage assembly to the cathode of the second power storage assembly; and
in the low-level mode,
the first single-pole double-throw switch is in a second switch position, thereby connecting the cathode of the first power storage assembly to the cathode of the second power storage assembly; and
the second single-pole double-throw switch is in a second switch position, thereby connecting the anode of the first power storage assembly to the anode of the second power storage assembly.

Optionally, in an embodiment of the present application:
the one or more switching units each include two single-pole double-throw switches;
in the high-level mode,
the first of the two single-pole double-throw switches is in an off position, and
the second of the two single-pole double-throw switches is in an on position, thereby connecting the anode of the first power storage assembly to the cathode of the second power storage assembly; and
in the low-level mode,
the first of the two single-pole double-throw switches is in an on position, thereby connecting the cathode of the first power storage assembly to the cathode of the second power storage assembly; and
the second of the two single-pole double-throw switches is in an off position.

Optionally, in an embodiment of the present application, the energy storage further includes at least one charging unit switch, where the at least one charging unit switch is configured to connect or disconnect the first power storage assembly and the second power storage assembly to or from a charging unit.

Optionally, in the power box of an embodiment of the present application, in the high-level mode,
the anode of the light source board is connected to the anode of the first power storage assembly, and
the cathode of the light source board is connected to the cathode of the first power storage assembly.

Optionally, in an embodiment of the present application, the energy storage further includes at least one load switch, where the at least one load switch includes at least two or more poles, where in the high-level mode,
when the at least one load switch is set to one or more first switch positions:
the anode of the light source board is connected to the anode of the first power storage assembly, and
the cathode of the light source board is connected to the cathode of the first power storage assembly; and when the at least one load switch is set to one or more second switch positions:
the anode of the light source board is connected to the anode of the second power storage assembly, and
the cathode of the light source board is connected to the cathode of the first power storage assembly.

Optionally, in an embodiment of the present application, a control circuit is further included, which is configured to set the position of the at least one load switch according to a state parameter of at least one of the first power storage assembly and the second power storage assembly when in the high-level mode.

Optionally, in an embodiment of the present application:
in the high-level mode, the energy storage is configured to receive a charging voltage of 220 volts, or more than 240 volts, or more than 800 volts.

Optionally, in an embodiment of the present application, in charging configuration, the power storage is configured to provide a voltage of 48 volts or more than 36 volts to the fire emergency lighting lamp or the light source board.

Optionally, the emergency power box of an embodiment of the present application further includes an energy storage control unit, where the energy storage control unit is configured to select between the low-level mode and the high-level mode.

In these corresponding embodiments, according to the voltage change of an external power supply, the electrical connection relationship between the corresponding energy storage and the external power supply is dynamically adjusted, and/or, the electrical connection relationship between the corresponding energy storage and the light source board is dynamically adjusted. Therefore, through the centered energy storage, a stable feed channel is established between the external power supply such as batteries and the light source board, so that optical power of the light source board in the fire emergency lighting lamp is substantially constant.

For example, in some embodiments, a) the electrical connection relationship between the energy storage and the light source board is switched between a serial connection and a parallel connection through coordination of the switching unit, or b) adjust the electrical connection relationship between the storage and the external power supply is switched between a serial connection and a parallel connection through coordination of the switching unit, which enables an “external power supply→energy storage” feed channel and/or an “energy storage→light source board” feed channel can dynamically adapt to the voltage change of the external power supply, so that electrical energy obtained by the light source board of the terminal remains stable.

### Technical Effect

Since the filter/porous body encapsulates/surrounds the opening portion on the box body, and the pore diameter of the filter/porous body is small, under normal ambient pressure, water and liquid cannot pass through due to factors such as surface tension of liquid, and watertightness is provided. However, gases can pass through the filter/porous body. Therefore, gas communication is formed between the inside of the box body and the outside of the box body through the filter/porous body, but liquid communication cannot be formed between the outside and inside of the box body. In this way, all portions of the box body except the filter/porous body remain watertightness and gas tightness, while the filter only has watertightness and no gas tightness. With such box body structure, the gases in the box body can and only can be discharged out of the box body via the filter/porous body. Liquid and dust outside the box body cannot enter the box body. In this way, the power box has both a high watertight level and high air permeability. Generally speaking, water is not easy to enter the power box, and the power box is easily permeable to gas.

Moreover, because the whole box body is highly tight, factors such as electric arcs in the box body do not pass through any portion of the box, including the “filter”, to affect the external environment of the box body. Water, liquid, dust, etc. cannot penetrate through any position of the whole box body, and only the porous filter can allow the gases to pass through. This allows the power box with such structure to meet ingress protection standards of IP66 and IP67 in national standards.

In this way, water is not easy to enter the power box, the pressure of the gases for example discharged by the batteries in the box body can be continuously released, so that the power box is not easy to explode due to the accumulation of internal air pressure. The maximum pore diameter/average pore diameter of the porous structure of the filter element is within any of the following intervals: [0.01 microns, 250 microns], [0.05 microns, 150 microns], or [0.01 microns, 200 microns], [0.1 microns, 1.5 microns], [0.01 microns. 1 micron], [1 micron, 100 microns], [150 microns, 200 microns] or [100 microns, 180 microns]. The smaller the pore diameter, the stronger the watertightness. However, due to the size of gas molecules, gas density and other reasons, the filter/porous body with these pore diameters substantially does not prevent the gases in the box body from being discharged out of the box body through the filter.

### BRIEF DESCRIPTION OF THE DRAWINGS

The drawings described herein are intended to provide a further understanding of the present application, which constitute a part of the present application. The illustrative embodiments of the present application and the description thereof are for explaining the present application and do not constitute an undue limitation of the present application. In the drawings:

FIG. 1A is a schematic diagram of a structure of a power box according to an embodiment of the present disclosure;

FIG. 1B is a schematic diagram of a structure of a power box according to another embodiment of the present disclosure;

FIG. 2A is a schematic diagram of a stereoscopic structure of a power box according to an embodiment of the present disclosure;

FIG. 2B is a stereoscopic exploded view of the power box in FIG. 2A;

FIG. 2C is a stereoscopic exploded view of a box body and a battery assembly in the power box in FIG. 2A;

FIG. 2D is a stereoscopic exploded view of the battery assembly and one of gas release assemblies in FIG. 2C;

FIG. 2E is an enlarged, stereoscopic exploded view of the gas release assembly in FIG. 2D;

FIG. 2F is a partial cross-sectional view of the power box along a section line in FIG. 2A;

FIG. 2G is an enlarged schematic diagram of the gas release member in FIG. 2E;

FIG. 3A is a schematic diagram of a structure of a power box in a state that a box cover is opened according to an embodiment of the present disclosure;

FIG. 3B is a schematic diagram of a structure of a battery assembly and gas release assemblies thereon in FIG. 3A;

FIG. 3C is a stereoscopic exploded view of the power box in FIG. 3A;

FIG. 3D is a partially enlarged, stereoscopic exploded view of the gas release assembly in FIG. 3A;

FIG. 3E is a partial cross-sectional view of the power box along the diameter of the gas release assembly in FIG. 3A;

FIG. 4A is a schematic diagram of a stereoscopic structure of a power box according to an embodiment of the present disclosure;

FIG. 4B is a stereoscopic exploded view of the power box in FIG. 4A;

FIG. 4C is a partial cross-sectional view of the power box along a section line in FIG. 4A;

FIG. 5A is a schematic diagram of a stereoscopic structure of a power box according to an embodiment of the present disclosure;

FIG. 5B is a stereoscopic exploded view of the power box in FIG. 5A;

FIG. 5C is a further, stereoscopic exploded view of the power box in FIG. 5B;

FIG. 5D is a partial enlarged view of a power box cover in FIG. 5B;

FIG. 5E is an enlarged, stereoscopic exploded view of a gas release assembly in FIG. 5B.

FIG. 5F is a partial cross-sectional view of the power box along a section line in FIG. 5A;

FIG. 6A is a schematic diagram of a stereoscopic structure of a power box according to an embodiment of the present disclosure;

FIG. 6B is a stereoscopic exploded view of the power box in FIG. 6A;

FIG. 6C is an enlarged, stereoscopic exploded view of a gas release assembly in FIG. 6B;

FIG. 6D is an enlarged schematic diagram of the structure of the gas release member in FIG. 6C;

FIG. 6E is a stereoscopic exploded view of a portion of a battery assembly in FIG. 6B.

FIG. 6F is a partially enlarged schematic diagram of components such as a gas collection cover in FIG. 6E;

FIG. 6G is a partial cross-sectional view of the power box along a direction perpendicular to a section line in FIG. 5A;

FIG. 6H is a cross-sectional view of the power box along a direction perpendicular to a section line in FIG. 5A;

FIG. 7 is a flowchart of a method for constructing an exhaust channel for a power box according to an embodiment of the present disclosure;

FIG. 8 is a flowchart of a method for constructing an exhaust channel for a power box according to another embodiment of the present disclosure; and

FIG. 9 shows a schematic diagram of feed topology between an energy storage in a power box according to an embodiment of the present disclosure and a light source board in an external lamp.

In the description of the drawings, the same, similar or corresponding reference numerals represent the same, similar or corresponding units, elements or functions.

### DETAILED DESCRIPTION OF THE EMBODIMENTS

Reference will now be made in detail to embodiments, and examples of these embodiments are illustrated in the accompanying drawings. In the following detailed description, numerous specific details are set forth to provide a thorough understanding of the various described embodiments. However, it will be apparent to those of ordinary skill in the art that the various described embodiments can be practiced without these specific details. In other instances, well-known methods, processes, components, circuits, and networks are not described in detail so as not to unnecessarily obscure aspects of the embodiments.

The terms used in the description of the various embodiments herein are for the purpose of describing particular embodiments only and are not intended to be limiting. As used in the description of the various embodiments and in the appended claims, the singular forms “a”, “an”, and “the” are intended to include the plural forms as well, unless the context clearly indicates otherwise. It will also be understood that the term “and/or” as used herein refers to and cover any and all possible combinations of one or more of the items listed in association. It will also be understood that the terms “includes”, “including”, “comprises” and/or “comprising” when used in this specification specify the presence of stated features, integers, steps, operations, elements and/or components, but do not exclude the presence or addition of one or more other features, integers, steps, operations, elements, components and/or groups thereof.

Depending on the context, the word “through” as used in this application can be interpreted as “by”, “by virtue of” or “by means of”. Depending on the context, the words “if” as used herein can be interpreted as “at the time of” or “when”, or “in response to determination”, or “in response to detection”. Similarly, depending on the context, “at the time of” or “when” in some embodiments may also be interpreted as conditional assumptions such as “if”. Similarly, depending on the context, the phrase “if (stated condition or event)”, “if (stated condition or event) is determined” or “if (stated condition or event) is detected” may be interpreted as “when (stated condition or event) is determined” or “in response to determining (stated condition or event)” or “when (stated condition or event) is detected”. Similarly, depending on the context, the phrase “in response to (stated condition or event)” in some embodiments may be interpreted as “in response to detecting (stated condition or event)” or “in response to the fact that (stated condition or event) is detected”.

It should be understood that although the terms first, second, third, etc. may be used in the present disclosure to describe various information, these pieces of information should not be limited to these terms. These terms are only used to distinguish the same type of information from each other. For example, the first may also be referred to as the second, and vice versa, without departing from the scope of the present disclosure. Depending on the context, the words “if” as used herein can be interpreted as “at the time of”, “when”, or “in response to determination”.

The present application is further explained below by way of embodiments, but the present application is not limited to the scope of the embodiments.

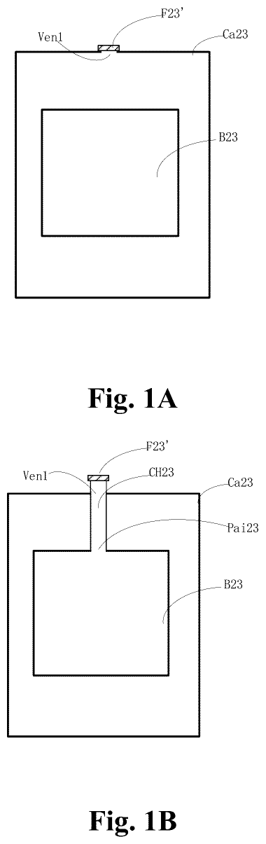

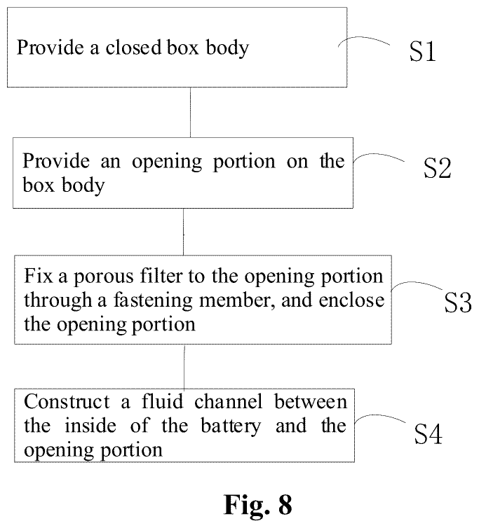

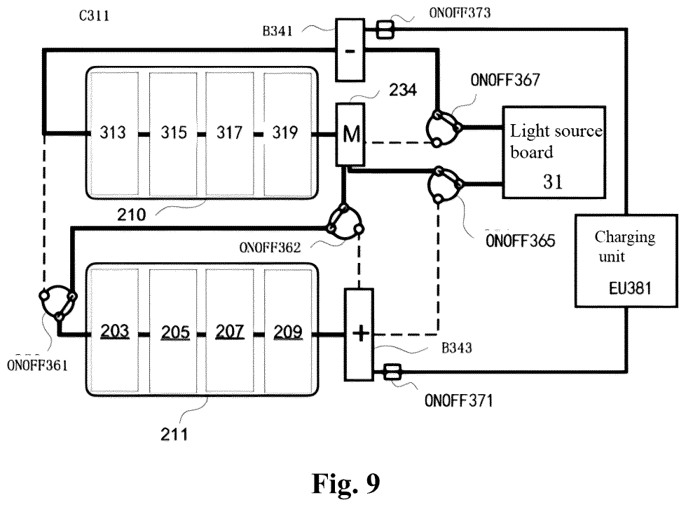

In embodiments shown in FIG. 7 and FIG. 8, a method for constructing an exhaust channel for a power box is provided, and the method for constructing the exhaust channel will be described with reference to FIG. 1A to FIG. 6H. The method for constructing the exhaust channel includes the following steps:
S1: Provide a closed box body Ca23.
S2: Provide an opening portion Ven1 on box body Ca23.
S3: Fix a porous filter F23 to the opening portion Ven1 through fastening members Na23, D231, or G231, and enclose the opening portion Ven1.

Through steps S1 and S2, an opening is provided in an integrally closed box body Ca23, and a porous filter F23 is fixed at this opening, and this porous filter F23 forms an enclosing structure for the opening portion. Since the pore diameter of the porous filter is small, under normal ambient pressure, water and liquid cannot pass through the porous filter due to factors such as surface tension of liquid, and watertightness is provided. However, gases can pass through the porous filter. Therefore, gas communication can be formed between the inside of the box body Ca23 and the outside of the box body Ca23 through the porous filter, but fluid communication cannot be formed between the inside and outside of the box body. In this way, all portions of the box body remain watertightness and gas tightness except the porous filter, while the porous filter F23 only has watertightness and no gas tightness. With such box body structure, the gases in the box body can and only can be discharged out of the box body Ca23 via the porous filter. Liquid outside the box body Ca23 cannot enter the box body. In this way, the power box has both a high watertight level and high air permeability. Generally speaking, water is not easy to enter the power box, and the power box is easily permeable to gas. Water, liquid, dust, etc. cannot penetrate through any position of the whole box body, and only the porous filter can allow the gases to be discharged. This makes the power box with such exhaust channel, which meets ingress protection of IP66 and IP67 in national standards.

Optionally, in some embodiments, at least one battery assembly B23 is accommodated in the power box, and the battery assembly B23 is capable of discharging gases. The method further includes the following step:
S4: Construct a fluid channel CH23 between the inside of the battery assembly B23 and the opening portion Ven1. In this way, gases escaped from a battery assembly B23 are not dispersed in the box body Ca23, but are directly guided to the opening portion Ven1 through an exhaust pipe Con232, and intensively discharged out of the box body through the porous filter F23 enclosed on the opening portion Ven1.

Optionally, in some embodiments, step S4 further includes the following steps:
S41: Cover an exhaust port Pai23 or Pai23′ of the at least one battery assembly B23 or an exhaust groove SL23 where the exhaust port is located with a gas collection cover G232 or G232′.
S42: Hermetically connect the gas collection cover G232 or G232′ with the periphery of a notch of the exhaust groove SL23 or the exhaust port Pai23 or Pai23′.
S43: Construct a first section of the fluid channel CH23 between the opening portion Ven1 and the exhaust vent Pai23/exhaust port Pai23′.

Optionally, in some embodiments, step S43 further includes the following steps:
S431: Enable fluid communication between a) the opening portion Ven1 and b) the exhaust vent Pai23/exhaust port Pai23′ through an exhaust pipe Con232.
S432: Use a) a pipe fastener G391 that fits a first end TC1 of the exhaust pipe Con232 and/or b) a hollow gas release member V23 that fits a second end TC2 of the exhaust pipe Con232 to fix the exhaust pipe Con232.
S433: Construct a second section of the fluid channel CH23 between a gas outlet OU23 of the second end TC2 of the exhaust pipe Con232 and the opening portion Ven1.

Optionally, in some embodiments, step S433 further includes the following steps:
S4331: Insert the second end TC2 of the exhaust pipe Con232 into a hollow chamber of the gas release member V23, thereby enabling the gas outlet OU23 to be in fluid communication with the porous filter F23 or a surface thereof through a gas release port Fa23 of the gas release member V23.
S4332: Shape the porous filter F23 into a hollow cylinder/hollow column, and fit at least a portion of the gas release member V23 in a sleeving manner.
S4333: Protrude the opening portion Ven1 corresponding to the porous filter F23 to the outside of the box body Ca23 and shape into any of the following: a circular cylinder, a hollow cylinder, a cavity, a tubular cavity, or a finger ring shape.
S4333: Hermetically engage and fix the porous filter F23 to the opening portion Ven1 through fastening members Na23, D231 and G231, so that the fastening members Na23, D231 and G231 cooperate with the porous filter F23 to enclose the opening portion Ven1.

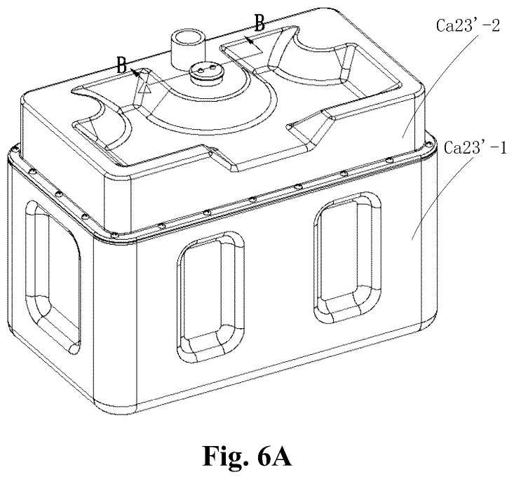

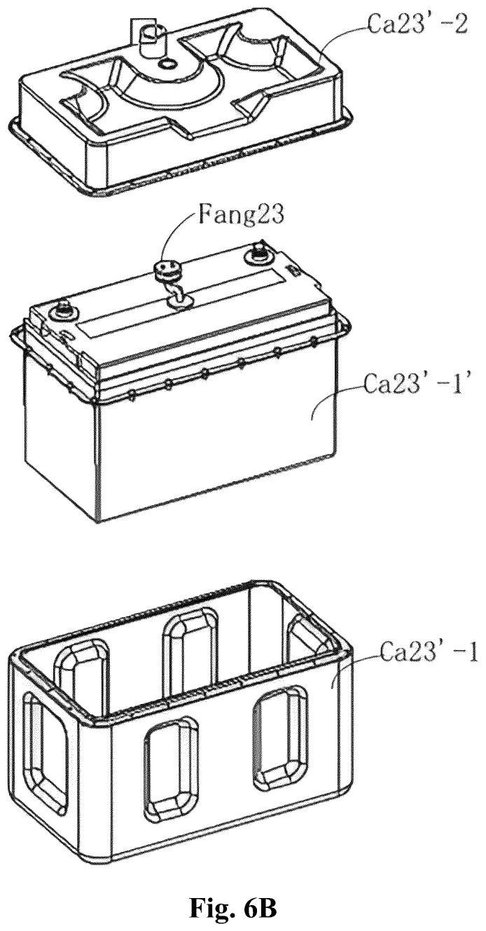

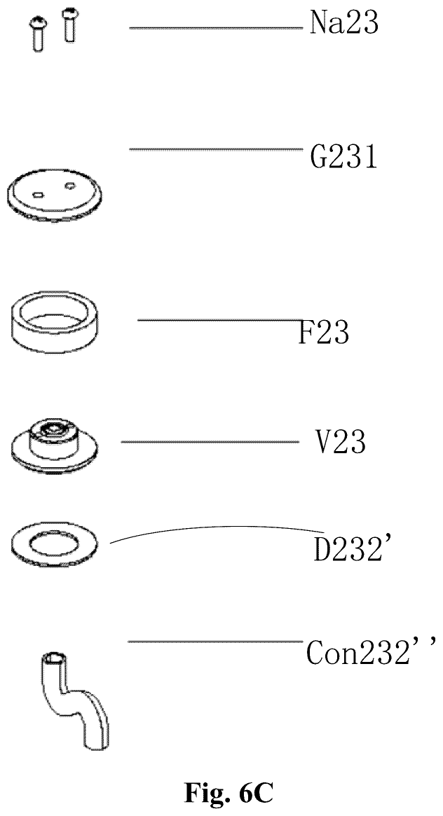

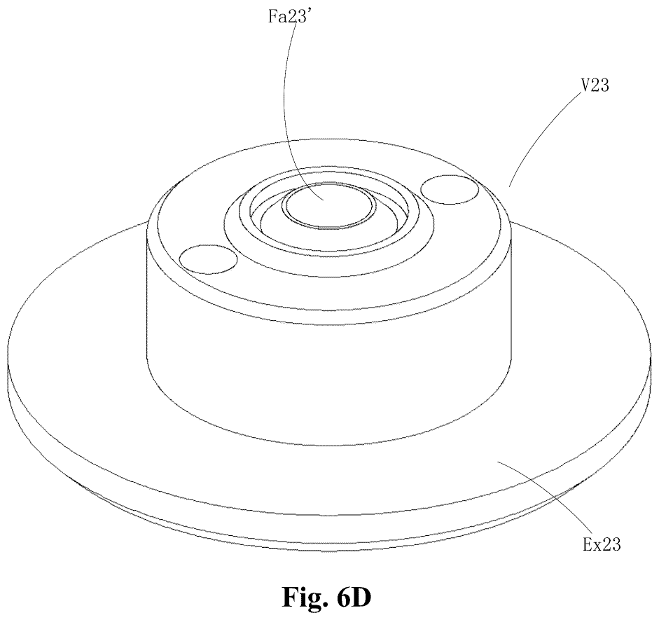

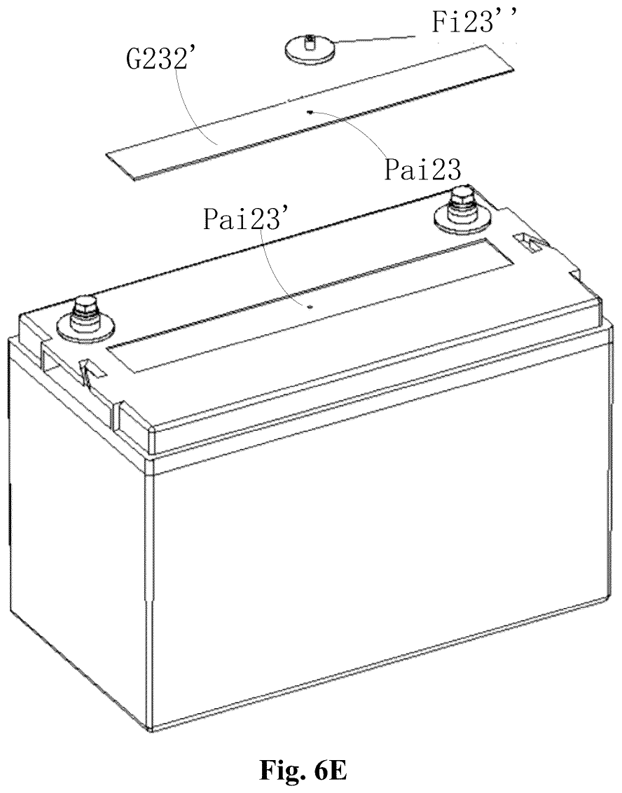

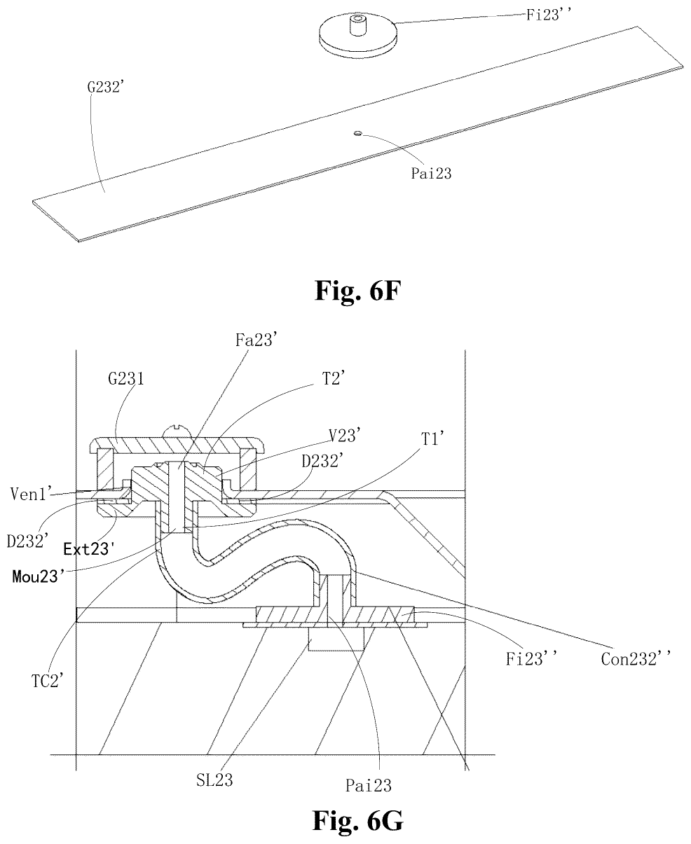

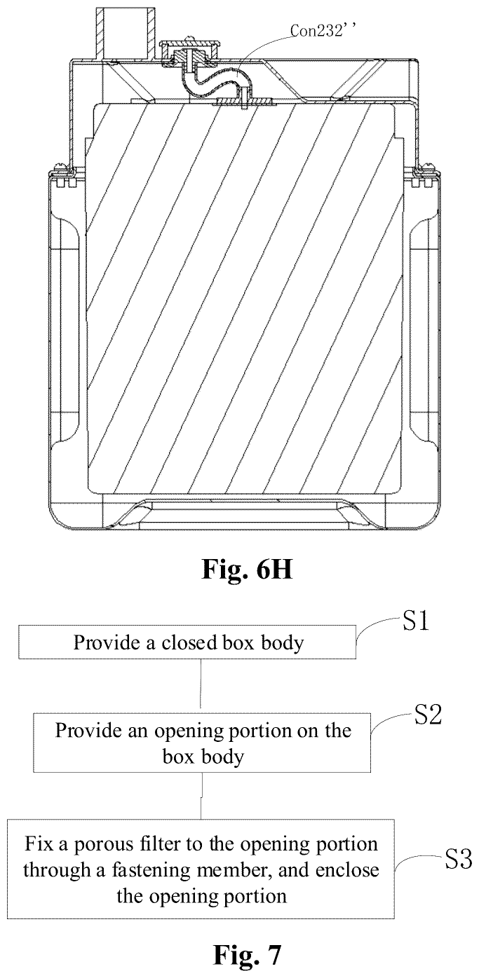

Optionally, in some embodiments, the fastening member includes a fixing cover G231, and the porous filter F23 is provided with a first port TER1 and a second port TER2 that are in communication through the inside of the porous filter. The step S4333 further includes the step:
closing the second port TER2 of the porous filter F23 through the fixing cover G231, and pressing and fixing the first port TER1 on an open end face of the opening portion Ven1 to hermetically connect the opening portion Ven1. The method further includes the following steps:
S5: Arrange sealing members D232′ or D232, and D233′ or D233 at one or more of the following places: a) between the filter F23 and the fastening member, or b) between the filter F23 and the opening portion Ven1, or c) between the fixing cover G231 and the second port TER2; or d) between an inner side of the opening portion Ven2 and the gas collection cover G232 or G232′; or e) between the opening portion Ven1 and the gas release member V23; or f) between an inner wall of the opening portion Ven1 and an outer pipe wall of the exhaust pipe; or g) between the first end TC1 of the exhaust pipe Con232 and the exhaust vent Pai23; or h) between the first end TC1 of the exhaust pipe Con232 and the pipe fastener G391.
S6: Shape a plurality of opposite walls of the box body Ca23 to be concave inward to abut against/approach the battery assembly B23, where the opposite walls include: i) a top wall, a bottom wall, and/or ii) opposite side walls, as shown in FIG. 6B, etc.
S7: Shape the porous filter F23 such that a maximum pore diameter/average pore diameter thereof is within any of the following intervals: [0.01 microns, 300 microns], [0.1 microns, 1.5 microns], [0.01 microns, 1 micron], [1 micron, 100 microns], [150 microns, 200 microns] or [100 microns, 180 microns], [0.05 microns, 150 microns], or [0.01 microns, 200 microns].

The enclosing is watertight covering or watertight enclosing.

The sealing members D232′ or D232, and D233′ or D233 are elastic members, the sealing members are made of material, and the sealing members are shaped into gaskets, washers, or O-rings.

The hermetical engagement is gas-tight coupling, and gas-tight coupling is a gas-tight and liquid-tight threaded connection or chemical bounding; or
the engagement is hermetical engagement, and the hermetical engagement is a hermetical connection/hermetical sleeve fitting/hermetical sleeve connection and has liquid tightness and/or gas tightness, and the hermetical engagement includes a threaded connection; or
the engagement has fluid communication;
the communication is fluid communication and/or hermetical communication; and
the fluid communication is gas communication.

A gas inlet I23 is in hermetical communication with the exhaust vent Pai23, and the filter F23 closes the gas outlet, thereby forming a fluid channel CH23, which provides a fluid-tight channel or a gas-tight channel between the exhaust vent Pai23 and the filter F23, and provides a fluid channel by using the filter F23, which is in gas communication but not in liquid communication, between the inside and outside of the box body Ca23.

The watertightness of the filter F23 is stronger than the gas tightness. The filter F23 has gas permeability, and the filter F23 does not have water permeability under the same temperature and/or pressure conditions.

The box body Ca23 has a closed/scaled structure except the filter F23, or maintains watertightness and gas tightness. The filter F23 has watertightness and no gas tightness.

One or more batteries B23 are lead-acid batteries B23 that are capable of discharging gases.

In another embodiment, further provided is a power box with a new structure, including:
a box body Ca23;
an opening portion Ven1, penetrating through a box wall of the box body Ca23;
a battery assembly B23, accommodated in the box body Ca23; and
a porous filter F23, encapsulating the opening portion Ven1, where
the porous filter F23 is mounted to the opening portion Ven1 through a fastener 233, and a maximum pore diameter/average pore diameter of the porous filter F23 is within the following interval: [0.01 microns, 300 microns].

Optionally, in some embodiments, the fastener 233 includes fastening members Na23, D231 and G231, or a chemical bonding layer. In this way, in some embodiments, the porous filter F23 is mounted to the opening portion through an explicit fastening member, the fastening members Na23, D231 and G231 cooperate with the porous filter F23 to enclose the opening portion Ven1. However, in some other embodiments, the porous filter F23 is mounted to the opening portion Ven1 by chemical means such as gluing. In this case, the porous filter F23 can independently enclose the opening portion Ven1. Such chemical bonding layer is also used as an implicit fastening means.

A maximum pore diameter/average pore diameter of the porous filter F23 is within any of the following intervals: [0.1 microns, 1.5 microns], [0.01 microns, 1 micron], [1 micron, 100 microns], [150 microns, 200 microns] or [100 microns, 180 microns], [0.05 microns, 150 microns], or [0.01 microns, 250 microns].

It should be noted that an encapsulating structure or enclosing structure of the filter F23 for the opening Ven1 here is not limited to directly blocking of the filter F23 in an opening of the opening portion Ven1, or direct, physical contacting between the filter F23 and the opening portion Ven1. For example, the filter F23 can further remain a certain distance from the opening to form the enclosing structure, for example, the filter F23 may not be spatially directly opposite to and aligned with the opening of the opening portion. In some embodiments, the filter F23 may cooperate with other fastening members to form an encapsulating structure for the opening portion Ven1. In other words, the filter F23 may be mounted to the opening portion Ven1 through the fastening members; and the filter F23 cooperates with the fastening members to enclose the opening portion Ven1. These deformed structures all belong to the enclosing/encapsulating structure of the filter for the opening portion.

In this embodiment, the gases in the box body are discharged through the porous filter element, where the porous filter element is provided a plurality of micropores. Due to the different densities of air and water, and certain liquid surface tension of water and liquid, the gases can be discharged from the inside of the box body to the outside of the box body Ca23 at the porous filter element, but the water outside the box body cannot enter the box body. Furthermore, since the lead-acid batteries and other devices in the box body may generate gases and head during work, the gases are usually discharged from the inside of the box body to the outside, rather than in an opposite direction. In this way, due to the gas exhaust and gas flows from the inside to the outside through the porous filter, dust, water, liquid, etc. outside the box body are difficult to be attached to the outer surface of the porous body, and even more impossible to penetrate the porous filter element and enter the box body.

The communication between the first end or the gas inlet of the exhaust pipe and the exhaust vent/exhaust port of the battery assembly is not limited to fluid communication formed by a direct connection therebetween. The exhaust pipe may also be indirectly connected to the inside of the battery assembly through other parts such as the gas collection cover and the exhaust groove, to form fluid communication. Therefore, the gases generated in the battery assembly is guided to the surface of the porous filter element and discharged out of the box body through the porous filter element. In this way, the gases in the box body Ca23 are discharged to the outside, and the external dust, foreign matters and liquid are prevented from entering the box body.

Furthermore, the gases generated by the lead-acid batteries are discharged to the outside through the porous filter element, and the porous filter element can prevent water from entering the device. Cooperating With the sealing performance of other positions on the box body, the box can reach a high waterproof level and meet the national explosion-proof standards, avoiding explosion caused by excessive gas concentration in the power box device, and improving the adaptability of the power box to an application site.

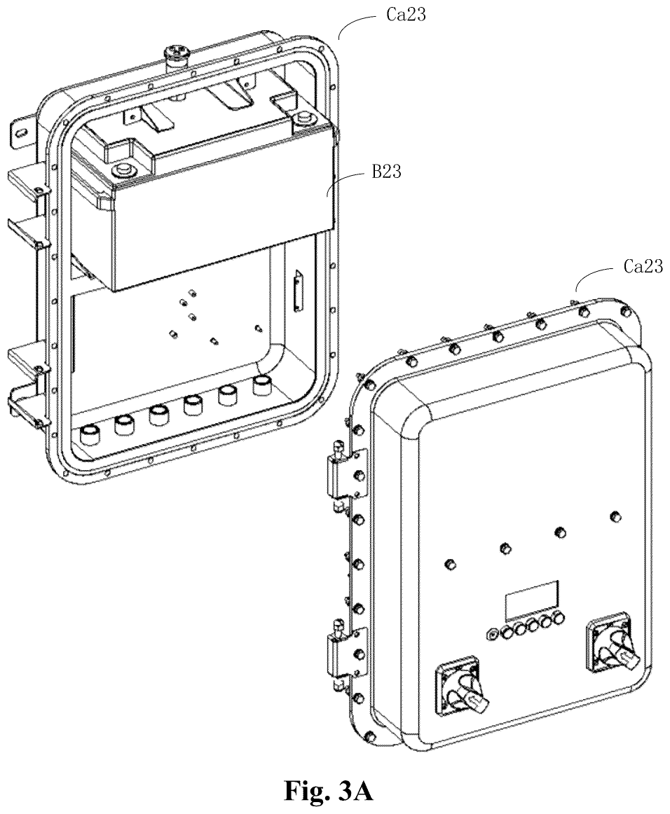

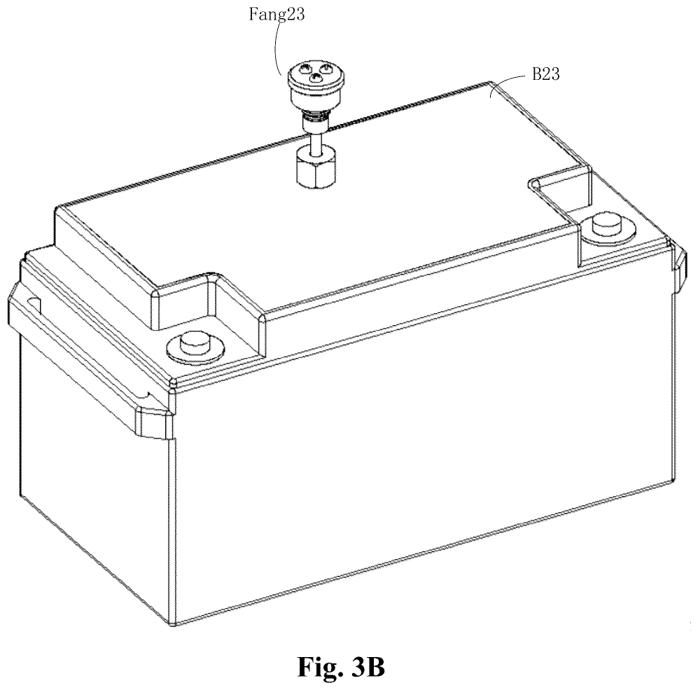

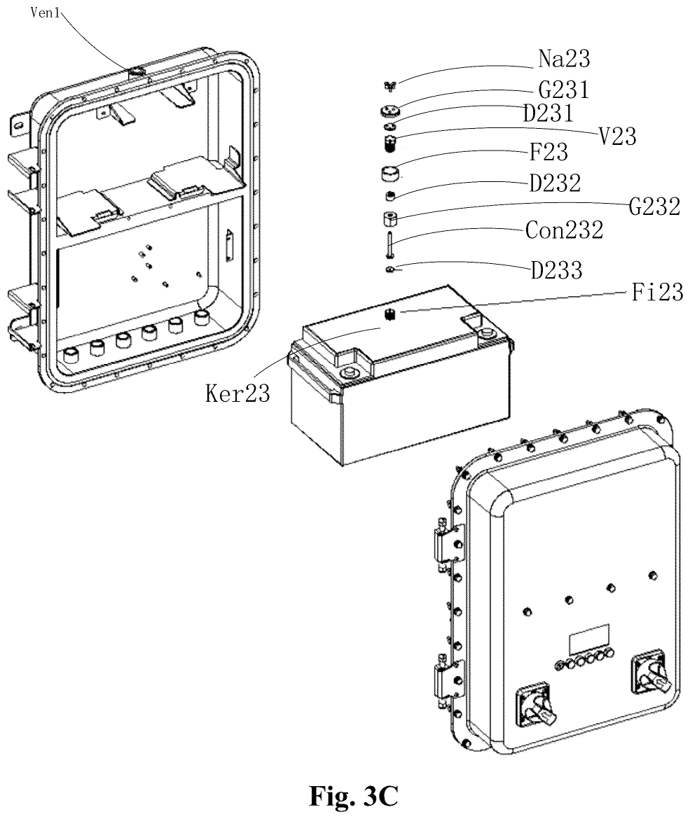

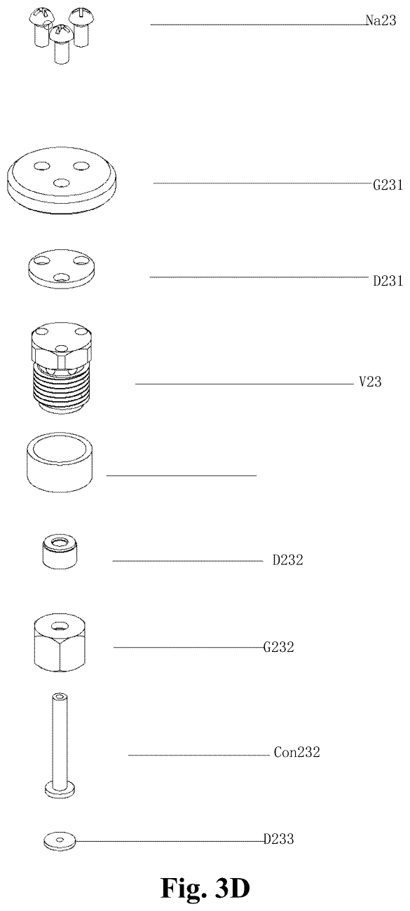

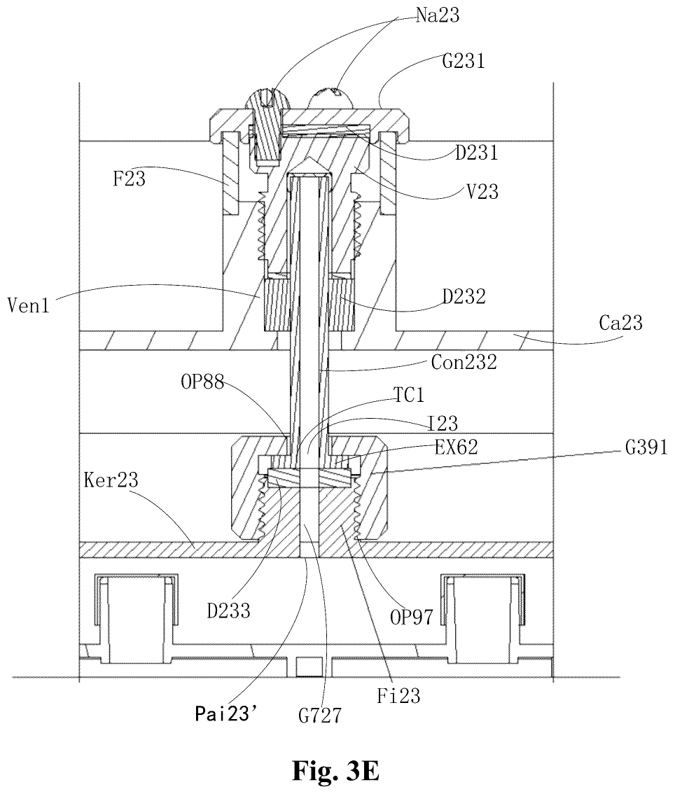

In the following, some other embodiments will be described in more detail with reference to FIG. 3 to FIG. 8.

Optionally, the power box of some embodiments further includes fastening members Na23, D231 and G231.

The filter F23 is fixed to the box body Ca23 through the fastening members Na23, D231 and G231. The filter F23, or the filter F23 cooperates with some fastening members, and can enclose/be engaged with the opening portion Ven1. So that the gases in the box body cannot escape from the box body Ca23 through the fastening members or the parts (such as gaps) between the filter F23 and the fastening members, but can only be discharged out of the box body Ca23 through the filter F23.

Certainly, in some other embodiments, the fastening members may not be provided, and the filter F23 is fixed to the box body by chemical bonding or the like to form an enclosing structure/encapsulating structure for the opening portion.

Optionally, in the power box of some embodiments, the fastening member further includes a press fixing member G231 and/or a connector Na23. The press fixing member G231 presses and fixes the filter F23 to the box body Ca23. Or, the connector Na23 is connected to the press fixing member G231 and the box body Ca23, and the filter F23 is clamped and fixed between the press fixing member G231 and the box body Ca23.

Optionally, in the power box of some embodiments, the filter F23 includes a filter element. The filter element has a porous structure or is made of a porous ceramic, metal or other material, and can be formed by pressing a nano-material with a porous structure.

In the porous structure of the filter element, a maximum pore diameter/average pore diameter is within any of the following intervals: [0.1 microns, 1.5 microns], [0.01 microns, 1 micron], [1 micron, 100 microns], [150 microns, 200 microns] or [100 microns, 180 microns].

Optionally, in some embodiments, the filter F23 corresponds to/fits the opening portion Ven1, and is suitable for being engaged with the opening portion Ven1.

Optionally, in the power box of some embodiments, the filter F23 is shaped into a cover body G231, and fits the shape of the opening portion Ven1.

Optionally, in the power box of some embodiments, the filter F23 has a hollow structure, and is shaped into any of the following: a circular cylinder, a hollow cylinder, a cavity, a tubular cavity, or a finger ring shape. The cross section of a section of the tubular cavity may be square, circular, elliptical, etc. The filter F23 is further provided with a first port TER1, and the first port TER1 is connected to the opening portion Ven1.

Optionally, in the power box of some embodiments, a second positioning portion Ste23 is arranged along the circumference of the opening portion Ven1, and the second positioning portion Ste23 fits/corresponds to the first port TER1. The first port TER1 is relatively fixed and/or connected to the opening portion Ven1 through the second positioning portion Ste23.

Optionally, in the power box of some embodiments, the filter F23 is further provided with a second port TER2 opposite to the first port TER1. The fixing cover G231 is pressed and fixed to the second port TER2 and encloses the second port TER2. A first positioning portion AO23 is arranged on the periphery of an inner side of the fixing cover G231, and fits/corresponds to the second port TER2. The fixing cover is relatively fixed to the second port TER2 through the first positioning portion AO23, and closes the second port TER2.

Optionally, in the power box of some embodiments, the first positioning portion AO23 is a groove or a step position. The first positioning portion AO23 is arranged on the inner side of the fixing cover along the circumference direction. The first positioning portion AO23 clamps and fixes the second port.

Optionally, in the power box of some embodiments, the second positioning portion Ste23 is a groove or a step position, the second positioning portion Ste23 is arranged along an end face of the opening portion Ven1, and the second positioning portion Ste23 clamps and fixes the first port TER1.

By arranging the above first positioning portion AO23 and the second positioning portion Ste23, the porous filter element F23 can be prevented from moving transversely. Moreover, when these positioning portions are implemented as grooves or step positions, a zigzag seam line is formed between the filter and the opening portion, which enhances the watertightness, so that even if there is no rubber pad between them, water and liquid are difficult to pass through this place, for example, between the opening portion Ven1/fixing cover, to enter the box body.

Optionally, the power box of some embodiments further includes a gas release member V23, where the gas release member V23 has a hollow structure, and the gas release member V23 is provided with a gas vent Fa23 and a mounting port Mou23.

The inside of the gas release member V23 is in communication with the outside through the gas vent Fa23. In this way, when the filter element F23 is shaped into a hollow cylinder or other shape, the inside of the gas release member V23 may be in gas communication with an internal chamber of the filter element F23; and then, gases in the box body pass through a cavity wall of the filter element F23 and escape to the outside of the box body. With such structure, optionally, the gas vent Fa23 and the mounting port Mou23 are in fluid communication through the inside of the gas release member V23, so that the gases in the box body can enter the gas release member V23 through the mounting port, and then escape to the outside of the gas vent Fa23.

Optionally, in the power box of some embodiments, the mounting port is engaged with the opening portion Ven1, and is in fluid communication with the filter F23 or an inner surface thereof through the inside of the gas release member V23 and the gas vent.

Optionally, in the power box of some embodiments, the opening portion Ven1 is shaped to protrude to the outside of the box body Ca23, as shown in FIG. 3 to FIG. 8, etc. The mounting port Mou23 is provided in a first end T1 of the gas release member V23, and the first end T1 is in threaded connection with the opening portion Ven1.

The gas vent is provided in a second end T2 of the gas release member V23, and is i) in fluid communication with the outside of the opening portion Ven1, or ii) exposed to the outside of the opening portion Ven1. The press fixing member includes a fixing cover G231, and the connector is a screw Na23.

The fixing cover G231 presses and fixes the filter F23 to the opening portion Ven1.

It should be noted that in some embodiments, the connector such as the screw may be directly connected to the box body, and as an alternative, the connectors such as the screw may also be further connected to the box body through an intermediate member such as the gas release member V23, so that the fixing cover is finally directly or indirectly connected to the box body, and therefore, the filter element located between the fixing cover and the box body may also be fixed relative to the box body to form a stable mechanical structure.

The screw Na23 passes through the fixing cover G231, and is in threaded connection with the second end T2 of the gas release member V23. With such connection/assembly structure, especially cooperating with positioning portions such as the fixing cover, and the groove and step position arranged at the opening portion, the opening portion, the gas release member and other components are pressed against each other in a gas flow direction, so as to prevent tripping and transverse displacement in the gas flow direction, destroying the gas tightness of the fluid channel and reducing the sealing effect, which further strengthens a sealing effect.

Optionally, in the power box of some embodiments, the first end TC1 and the second end TC2 of the exhaust pipe Con232 separately define a gas inlet and a gas outlet OU23. The battery assembly B23 is provided with an exhaust vent Pai23. The gas inlet I23 is in hermetical communication with the exhaust vent Pai23, so that gases escaping from the exhaust vent Pai23 of the battery assembly B23 may enter the exhaust pipe Con232 via the gas inlet I23.

Optionally, in the power box of some embodiments, the mounting port Mou23 is sleeved at the second end TC2 of the exhaust pipe Con232, and the gas outlet OU23 is in fluid communication with the gas vent Fa23; or
the second end OU23 of the exhaust pipe Con232 is inserted into the gas release member V23 from the mounting port Mou23, and the gas outlet OU23 is in fluid communication with the gas vent through the inside of the gas release member V23.

In some embodiments, an exhaust pipe Con232 is provided, and two ends OU23 and I23 of the exhaust pipe Con232 are separately in communication with the inside of the battery assembly and the outside of the box body, so that gases escaped from the battery assembly B23 are not dispersed in the box body, but are directly guided to the opening portion Ven1, and intensively discharged out of the box body Ca23 through a gas release assembly Fang23 composed of the gas release member and the filter fastened together. Harmful effects such as corrosion on the inner wall of the box body caused by the gases discharged from the battery assembly B23 are avoided.

Optionally, the exhaust pipe Con232 has a tubular structure. It can be understood that when the exhaust pipe Con232 adopts a tubular cavity, if two ends of the exhaust pipe have threads, cross sections of the two ends may be circular, and cross sections of other hollow portions may be arbitrarily optional, including but not limited to: round, square, oval, rectangular, etc. The overall shape of an explosion-proof cavity may be prismatic, square, elliptical.

Optionally, in the power box of some embodiments, the battery assembly B23 further includes a housing, and an exhaust vent Pai23 is provided in the housing.

However, in the power box of some other embodiments, the battery assembly B23 further includes a housing, a gas collection cover G232 or G232′, and one or more lead-acid batteries, where each lead-acid battery is provided with an exhaust port Pai23′. The housing is partially concave to form an exhaust groove SL23, and the exhaust port(s) Pai23′ provided in the one or more lead-acid batteries is/are all located in the exhaust groove SL23. The gas collection cover G232 or G232′ covers a notch of the exhaust groove SL23 and is connected/hermetically connected to the notch. In this structure, an opening for discharging gases provided in the gas collection cover is defined as the exhaust vent Pai23. An opening for discharging gases directly provided in the one or more lead-acid batteries is defined as the exhaust port Pai23′.

Optionally, in the power box of some embodiments, as shown in FIG. 6A to FIG. 6H, a first end T1′ of a gas release member V23′ extends from an opening portion Ven1′ into a box body Ca23′, and is engaged with a second end TC2′ of an exhaust pipe Con232″. A second end T2′/gas vent Fa23′ of the gas release member V23 is exposed to the outside of the opening portion Ven1′.

The exhaust pipe Con232″ is a flexible pipe, and is in flexible communication with an exhaust vent Pai23 and a mounting port Mou23′. A first end of the exhaust pipe Con232″ is engaged with the exhaust vent Pai23.

The flexible pipe may be provided with an internal gasket made of an clastic material, so that fluid may be in hermetical communication, and at the same time, the flexible pipe may be bent, twisted and rotated according to the needs of battery mounting orientation and operation, which brings convenience to the utilization of an internal space of the box body, and improves the assembly flexibility and manufacturability of the power box.

Optionally, the power box of some embodiments further includes a sealing member D232′. The sealing member D232′ is arranged between the opening portion Ven1′ and the gas release member V23′, further enhancing the gas tightness of the whole fluid channel at the opening portion Ven1′, so that gases are substantially guided to the gas release member V23 along the exhaust pipe Con232″, thereby being discharged out of the box body.

The first end T1′ of the gas release member V23 extends into the opening portion Ven1′, and is optionally in threaded connection with the opening portion. After extending into the opening portion, the first end T1′ of the gas release member V23 extends along an inner wall of the opening portion Ven1′ to the periphery of the opening portion Ven1′. An extension Ext23′ is clamped and fixed to an inner side of the opening portion Ven1′ through a sealing member. Since the sealing member D232′ is clamped and fixed between the extension Ext23′ and the inner side of the opening portion Ven1′, even the threaded connection between the first end T1′ of the gas release member V23 and the opening portion does not have good gas tightness, the gases are not leaked between a) the extension Ext23′ at the first end T1′ of the gas release member V23 and b) the inner side of the opening portion.

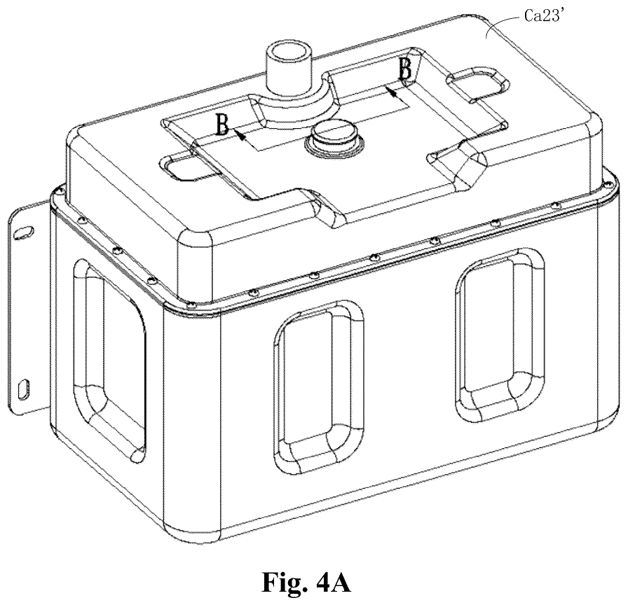

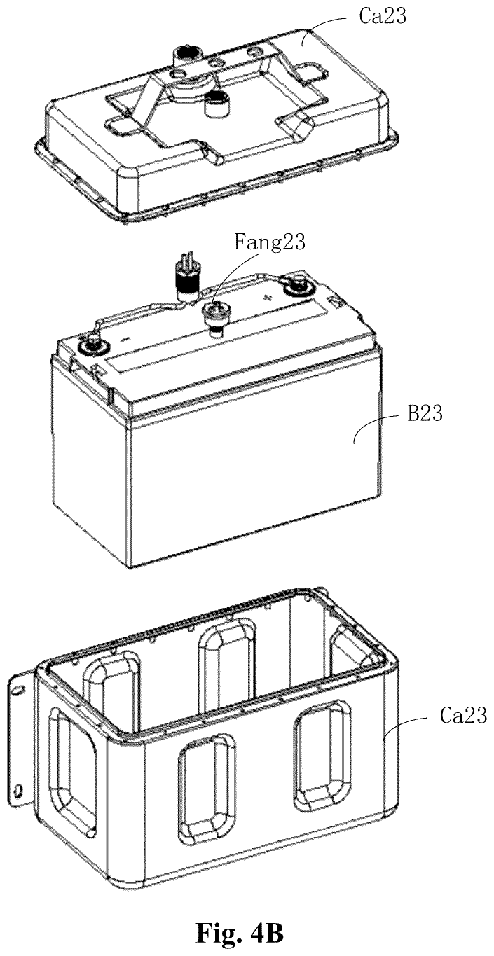

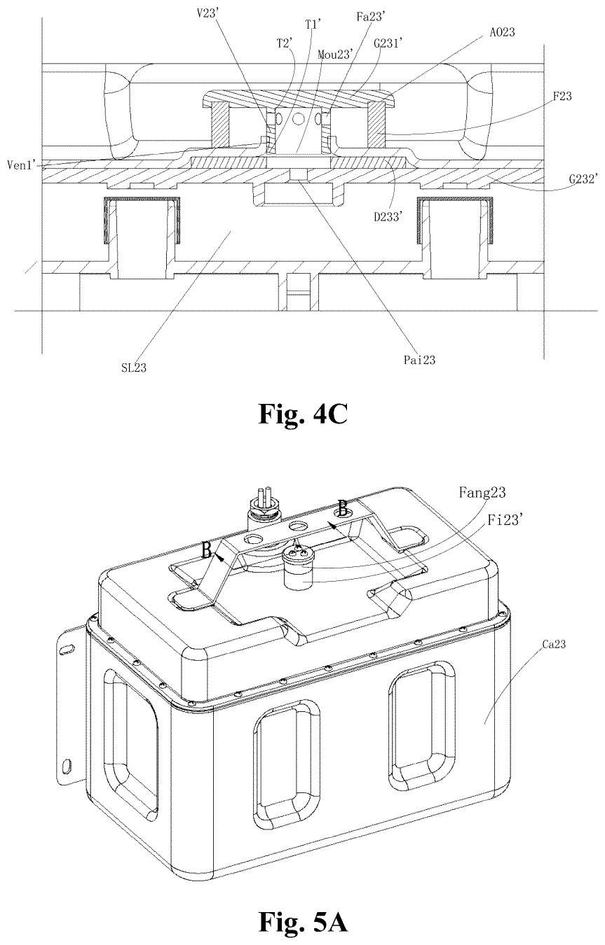

Optionally, in the power box of some embodiments, the box body has the equivalent volume as the battery assembly, rather than the internal volume of the box body being greater than the volume of the battery. In the power box with such “small box body”, as shown in FIG. 4A to FIG. 4C, a plurality of opposite walls of the box body Ca23′ may be concave inward to abut against/approach the battery assembly B23, where the opposite walls include: i) a top wall, a bottom wall, and/or ii) opposite side walls. With such structure, a displacement space of the battery is reduced, and if the box body abuts against the housing of the battery, it can help to fix the position of the battery in the box body, and enhance the structure stability of the whole power box.

In addition, for these power boxes with “small box bodies”, the opening portion Ven1′ and the housing of the battery assembly B23 have an extreme short distance therebetween and even form a close contact with each other, so in such structure, the exhaust pipe can be no longer arranged.

Since the gas release member V23′ has a hollow structure, the mounting port Mou23′ and the gas vent Fa23′ are in communication with each other through the inside of the gas release member V23′, the gas release member V23′ may also function as a “gas guide channel” like the exhaust pipes in other embodiments. Since the distance between the exhaust vent Pai23 in the battery assembly B23 and the mounting port Mou23′ is extremely short, gas leakage may be avoided by means of a sealing pad in this distance, to form a gas-tight channel. Therefore, in some embodiments as shown in FIG. 4C, etc., the structure of the opening portion Ven1′ protruding outward forms a small space in the box body. This space is filled with a sealing member D233′. The sealing member is located a) between the inner side of the opening portion Ven1′ and the gas collection cover G232′, or b) between the inner side of the opening portion Ven1 and the housing of the battery assembly. The sealing member D233′ surrounds i) the opening portion Ven1′ and ii) the exhaust vent Pai23, and forms a gas-tight channel at this position.

Optionally, the second end T2′ of the gas release member V23′ is integrally connected to the middle portion of an inner side of a fixing cover G231′. In this way, the screws and other connectors used in other embodiments may also be omitted. The gas release member V23′ is substantially perpendicular to the fixing cover G231′ and extends to the opening portion Ven1′, and the first end T1′ of the gas release member V23′ is in connection/sleeve fitting/sleeve connection/threaded connection with the opening portion Ven1′.

The first end T1′ of the gas release member V23 extends into the opening portion Ven1′/the box body Ca23′, and the mounting port Mou23′ is aligned with or in fluid communication with the exhaust vent Pai23. In this way, a fluid channel that has a shorter length and fewer parts, but is still gas-tight is formed.

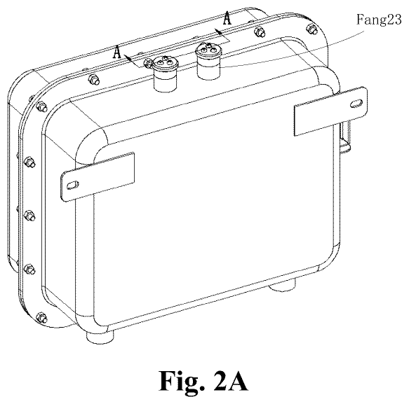

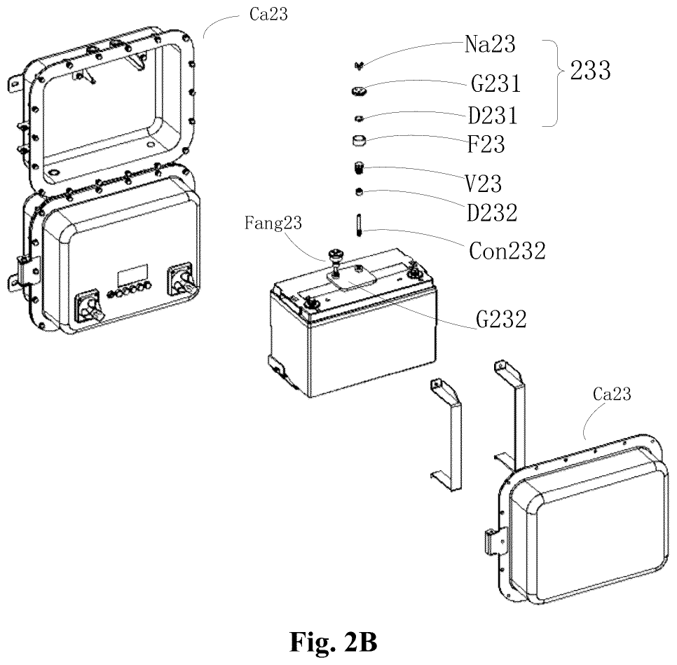

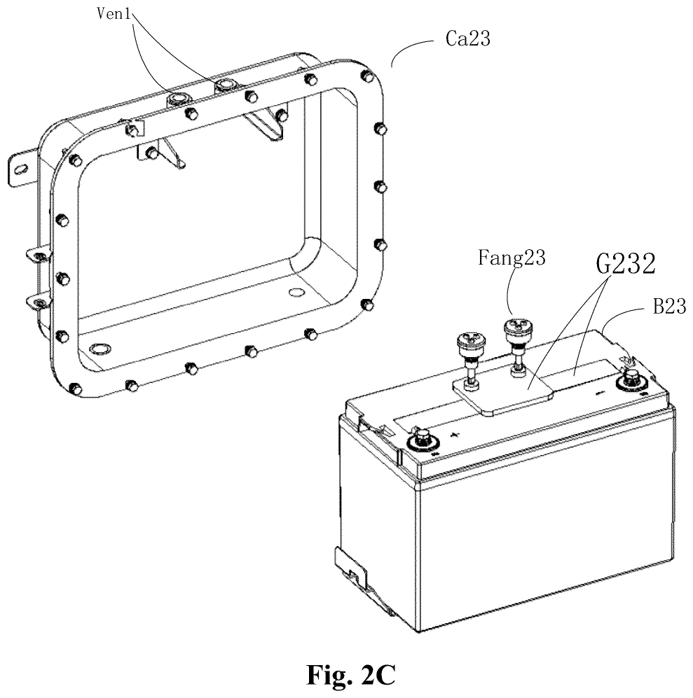

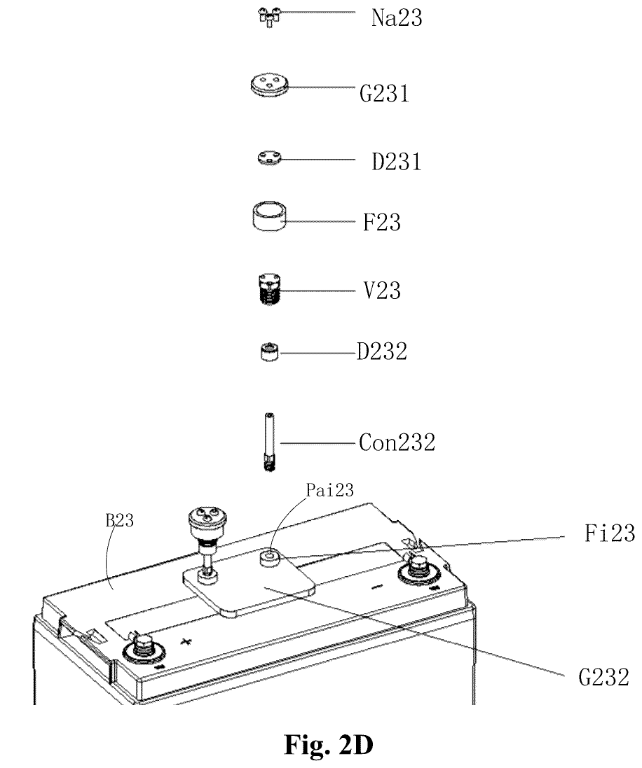

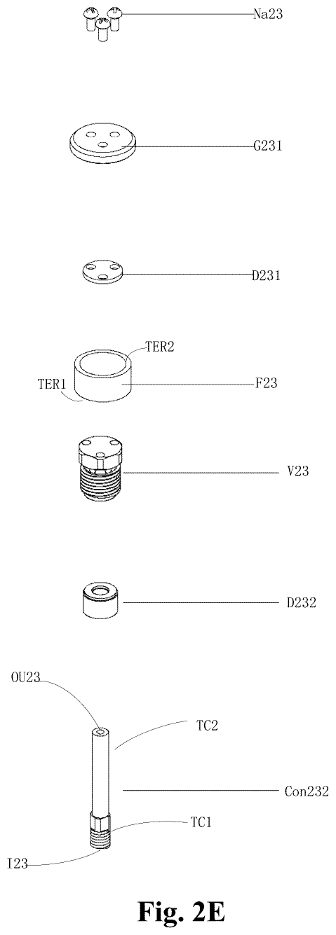

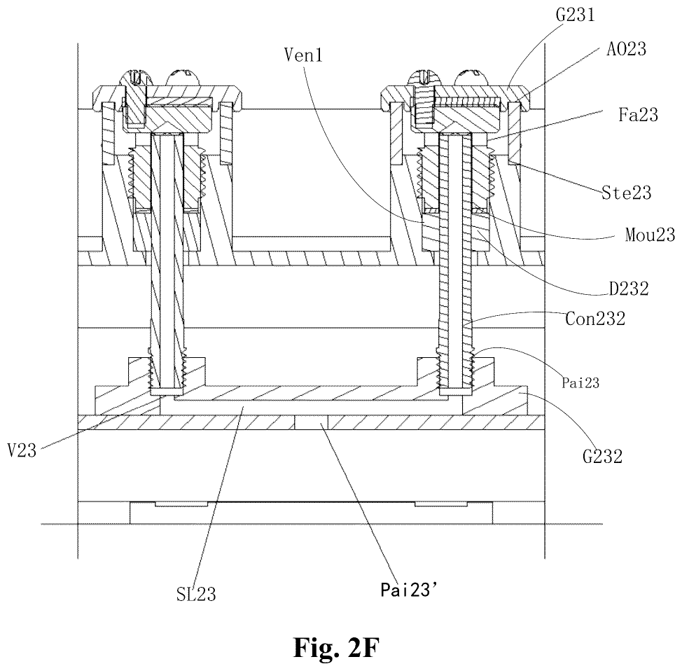

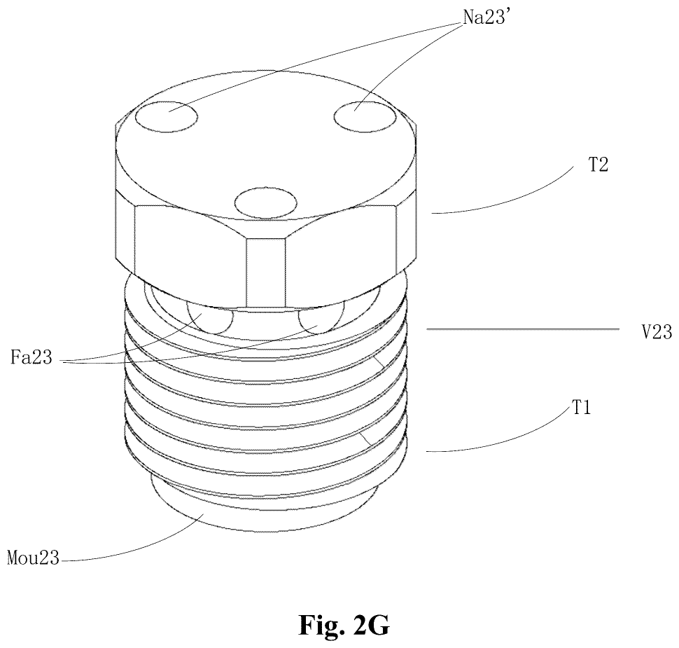

Optionally, in the power boxes as shown in FIG. 2A to FIG. 2G and FIG. 3A to FIG. 3E, the volume of the box body is significantly larger than the volume of the battery assembly. In the power box Ca23 with such a “large box body”,
the sealing member D232 is filled in the opening portion Ven1, and is located between a) the inner wall of the opening portion Ven1 and b) the outer pipe wall of the exhaust pipe Con232. Such arrangement structure of the sealing member at least blocks gases that are discharged to the filter F23 through the gas vent Fa23, and the gases flow back into a reflux channel of the opening portion along the threaded connection. The gas tightness and unidirectional fluidity of the whole fluid channel are enhanced, and the gases are prevented from flowing back into the box body.

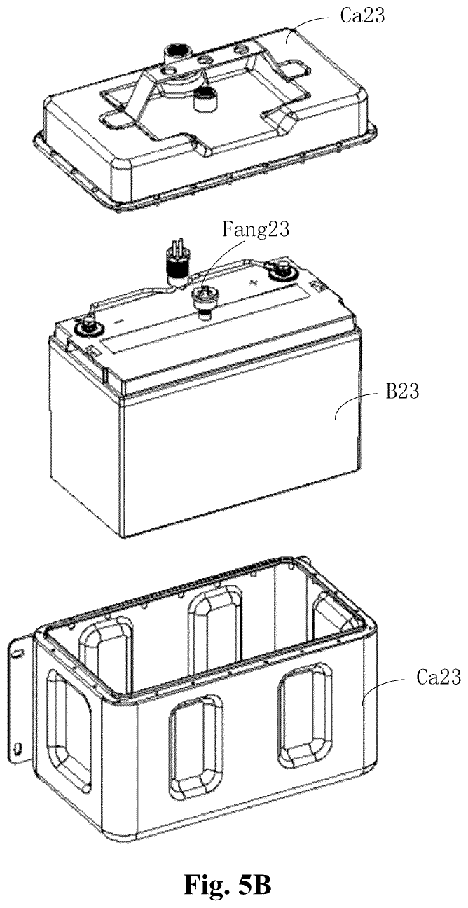

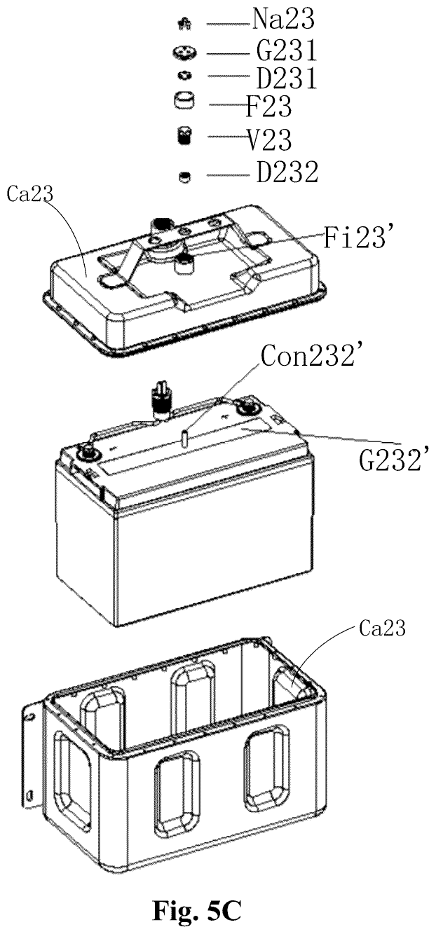

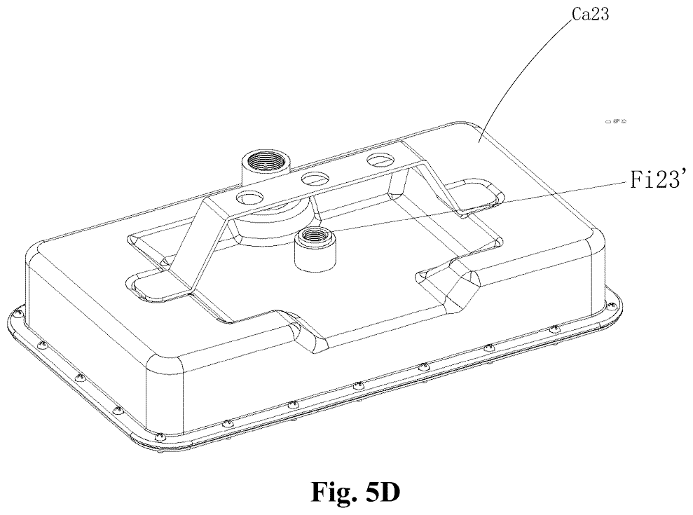

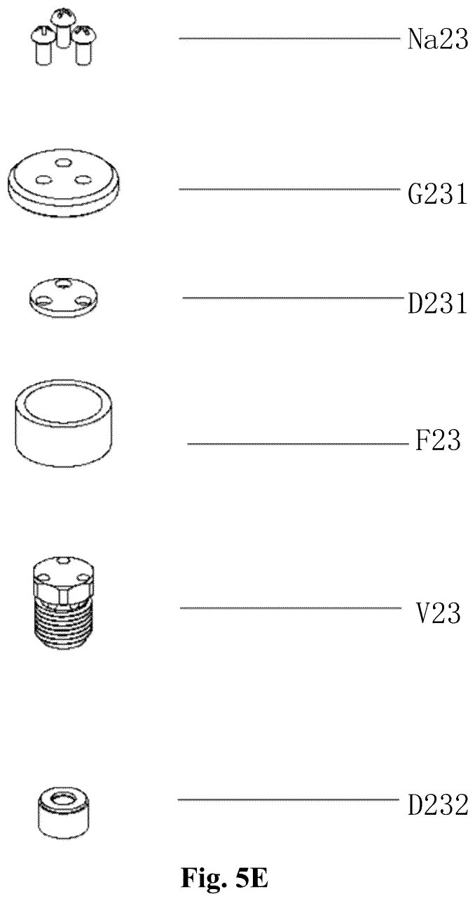

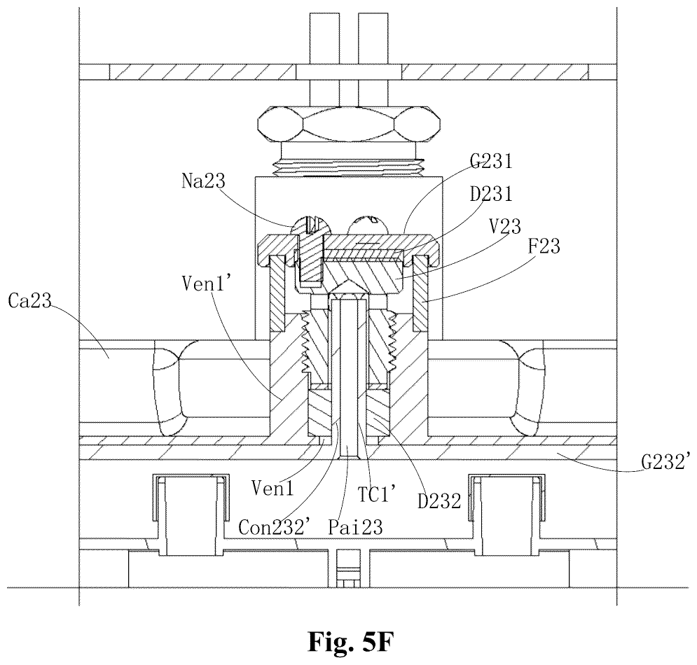

Optionally, in some power boxes with “small box bodies” as shown in FIG. 5A to FIG. 5F, if an exhaust pipe Con232′ is required, this exhaust pipe may have a relatively short size. In this case, a first end TC1′ of the exhaust pipe Con232′ may be fixed to the gas collection cover G232′ or the housing of the battery by welding or chemical bonding. A gas inlet (not shown in figures) provided at the first end TC1′ of the exhaust pipe Con232′ is in mutual communication/hermetical communication with the exhaust vent Pai23.

Optionally, in some power boxes with the “large box bodies” as shown in FIG. 3A to FIG. 3E, a fixing connector G391 and a sealing member D233 are further included. The first end TC1 of the exhaust pipe Con232 extends into the box body Ca23, and is engaged with the exhaust vent Pai23′ through the fixing connector G391.

The sealing member D233 is arranged between the first end TC1 of the exhaust pipe Con232 and the exhaust vent Pai23, and the sealing member D233 surrounds the exhaust vent Pai23, so that gas tightness is formed between the first end TC1 and the exhaust vent Pai23, and the two form a gas-tight fluid channel here.

Optionally, the fixing connector G391 further includes: a fixing member Fi23 and a pipe fastener G391.

The fixing member Fi23 is provided with a through hole G727. The fixing member Fi23 is in fluid communication with and engaged with the exhaust vent Pai23′. The fixing member Fi23 is fixed on the gas collection cover or a housing Ker23.

The pipe fastener G391 is connected to the fixing member Fi23 and the first end TC1 of the exhaust pipe Con232. The first end TC1 of the exhaust pipe Con232 and the fixing member Fi23 clamp and fix the sealing member D233. The scaling member D233 surrounds the through hole G727. The gas inlet I23 is in fluid communication with the through hole G727.

Optionally, in the power box of some embodiments, the pipe fastener G391 is provided with a first opening OP97 and a second opening OP88 opposite to each other which separately fit the fixing member Fi23 and the first end TC1 of the exhaust pipe Con232, to fasten and connect them. The first opening OP97 and the second opening OP88 are in communication with each other through the inside of the pipe fastener G391.

Further optionally, the first end TC1 of the exhaust pipe Con232 extends into the second opening OP88. The second opening OP88 is contracted inward, or the first end of the exhaust pipe Con232 extends outward/to the periphery along the transverse direction, and the extension portion EX62 is clamped into the second opening OP88. The transverse direction may be understood as: a direction perpendicular to the extension direction of the exhaust pipe Con232, or the “transverse direction” is perpendicular to the axial direction/length direction/extension direction of the exhaust pipe Con232.

The pipe fastener G391 is in mutual threaded connection with the fixing member Fi23, to extrude the first end TC1 of the exhaust pipe Con232 to the fixing member Fi23 through the second opening OP88.

Optionally, in the power box of some embodiments, a fluid channel CH23 is further included. As shown in FIG. 2, the fluid channel CH23 may be in communication with the inside of the battery and the opening portion of the box body Ca23. This fluid channel is composed of one or more of i) the exhaust pipe and the gas release member, or ii) the through holes, chambers and hollow portions in the fixing member and other parts, the opening portion of the box body, and the openings/holes/ports such as the gas vent and the exhaust vent, and iii) the sealing members between the parts. The fluid channel is a gas channel, which guides exhaust gases of the battery so that the gases can be intensively discharged out of the box body through the filter, and preferably, the gases cane be further prevented from randomly dispersing in the box body. For this fluid channel, those skilled in the art can also think of various other layouts to allow the exhaust gases to escape from a battery pack and be discharged out of the box body through the filter. Variations and embodiments of these fluid channels are within the spirit and scope of the present disclosure.

The screw Na23 passes through the fixing cover G231 from the outside of the box body Ca23, extends to the opening portion Ven1, and is in threaded connection with a screw hole Na23′ in the gas release member V23.

The sealing members D232, D233 and D233′ are elastic members. The sealing members D232, D233 and D233′ are made of an elastomer material. The sealing members D232, D233 and D233′ are shaped into gaskets, washers, or O-rings. The sealing members D232, D233 and D233′ can be used to provide a fluid-tight connection between the inside of the battery assembly B23 and the outside of the box body Ca23, so that a gas flow can communicate and flow hermetically.

The sealing member D232 is filled in the opening portion Ven1. The sealing member D232 is located between two or three of: a) the inner wall of the opening portion Ven1, b) the outer pipe wall of the exhaust pipe Con232, and c) the second end TC2 of the exhaust pipe Con232.

The gas collection cover G232 or G232′ hermetically covers the exhaust port Pai23′. A sealant is filled between the gas collection cover G232 or G232′ and the housing Ker23 covered by the gas collection cover.

“Hermetical engagement” in some embodiments is gas-tight coupling. The gas-tight coupling is a gas-tight and liquid-tight threaded connection or chemical bonding; or
“engagement” in some embodiments is hermetical engagement. The hermetical engagement is hermetical connection/hermetical sleeve fitting/hermetical sleeve connection, has liquid tightness and/or gas tightness, and includes a threaded connection; or
“engagement” in some embodiments has fluid communication;
“communication” in some embodiments is fluid communication and/or hermetical communication; and the fluid communication is gas communication.

Optionally, in some embodiments, the gas inlet I23 of the exhaust pipe is in hermetical communication with the exhaust vent Pai23, and the filter F23 closes the gas outlet OU23, thereby forming a fluid channel, which provides a fluid-tight channel or a gas-tight fluid channel between the exhaust vent Pai23 and the filter F23, and provides a fluid channel by using the filter F23, which is in gas communication but not in liquid communication, between the inside and outside of the box body Ca23.

With reference to FIG. 6A and FIG. 6B, in this embodiment, the small box body includes a box main body Ca23′-1 and a box cover Ca23′-2 which can be hermetically connected to form a closed box body. The box main body Ca23′-1 in the closed box body may also be implemented as a housing Ca23′-1 of the battery or the battery assembly, that is, the housing Ca23′-1′ of the battery/battery assembly is used as the box main body Ca23′-1, or as a portion of the box body Ca23′. When the box cover Ca23′-2 as shown in FIG. 6B is hermetically connected to the housing Ca23′-1′ of the battery/battery assembly, a closed space may also be formed. Gases discharged from the exhaust vent of the battery are discharged out of the box body Ca23′-2 or Ca23′-1′ through the gas release assembly Fang23 in the closed space. In this case, the box main body Ca23′-1 in FIG. 6B is no longer required.

It should be noted that in some embodiments described above and below, “bridge”, “fixedly connect”, “fix” and “connect” are not limited to direct connection or direct contact between two elements or assemblies, but may be implemented as direct connection or indirect connection formed by devices such as resistors.

Therefore, the present application may use the expressions “couple”, “fix” and “connect” and their derivatives to describe some embodiments. It should be understood that these terms are not meant to be synonymous with each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. However, the term “couple” may also mean that two or more elements are not in direct contact with each other, but still operate or interact with each other. Embodiment are not limited to this context.

The emergency power box in some embodiments of the present application is externally connected to an emergency lighting lamp, and the emergency power box includes a power storage assembly, which is connected between a power supply/battery in the power box and the external emergency lighting lamp.

FIG. 11 shows a macroscopic schematic diagram of electrical connection topology C311 between schematic power storage assemblies 210 and 211 and a light source board, in the power storage assemblies, electrical assemblies, and sub-assemblies in a power box according to some embodiments of the present application. Each of the power storage assemblies 210 and 211 include a connection end anode and a connection end cathode. For example, the power storage assembly 210 is provided with a connection end anode connected to a bus 234 and a connection end cathode connected to a bus B341. In addition, the power storage assembly 211 is provided with a connection end anode connected to a bus B343 and a connection end cathode connected to a switch ONOFF361.

As shown in FIG. 11, switches ONOFF361, ONOFF362, ONOFF365 and ONOFF367 are single-pole double-throw switches. For example, any or all of the switches ONOFF361, ONOFF362, ONOFF365 and ONOFF367 may be “ON-ON” or “ON-OFF-ON” type of single-pole double-throw switches. Any or all of the switches ONOFF361, ONOFF362, ONOFF365 and ONOFF367 may include one or more contactors, relays and transistors. For example, all the switches ONOFF361, ONOFF362, ONOFF365 and ONOFF367 may be single-pole double-throw contactors. In another embodiments, the switches ONOFF361, ONOFF362, ONOFF365 and ONOFF367 each may include two single-pole single-throw contactors that are appropriately wired to achieve single-pole double-throw connectivity. As shown in FIG. 11, both the switches ONOFF371 and ONOFF373 are single-pole single-throw switches, configured to connect and disconnect a corresponding connection end of a battery charging unit EU381 to and from the buses B341 and B343. Either or both of the switches ONOFF371 and ONOFF373 may include a contactor, a relay and a transistor.

As shown in FIG. 11, the power storage assemblies 210 and 211 are coupled in series. For example, the switch ONOFF361 and the switch ONOFF362 are configured to connect the connection end anode of the power storage assembly 210 to the connection cathode of the power storage assembly 211. The light source board 31 of the emergency lighting lamp to which the emergency power box is connected in FIG. 2B, FIG. 3C, etc. is shown to be connected to the power storage assembly 210 through the switch ONOFF367 and the switch ONOFF365. As shown in FIG. 11, the switch ONOFF367 connects the bus B341 to a cathode connection end of the light source board 31, and the switch ONOFF365 connects the bus 234 to an anode connection end of the light source board 31.

In some embodiments, the power storage assembly 210 may also be referred to as a battery cell, and may also include modules 313, 315, 317 and 319. In some embodiments, the power storage assembly 211 may further include submodules 203, 205, 207, and 209, and may also be referred to as battery cells. For example, the power storage assembly 210 may be referred to as “a string of battery cells” (that is, battery cells coupled in series). The voltage of the power storage assembly 210 may be a combination of the battery cells 313, 315, 317, and 319. For example, as schematically shown in FIG. 11, the voltage of the power storage assembly 210 is the sum of the voltages of each of the battery cells 313, 315, 317, and 319. In another embodiment, the power storage assembly (e.g., the power storage assembly 210 or the power storage assembly 211) may include one or more battery cells coupled in parallel (e.g., to increase the current capacity of the power storage assembly). For the sake of clarity, the present application is described in terms of the power storage assembly.

For simplicity, topology C311 illustrates two power storage assemblies, but according to the present application, more than two power storage assemblies can be managed. For example, three power storage assemblies separately operating at 220V can be connected in parallel (e.g., charging at 110V) or in series (e.g., charging at 220 volts and 240 volts) through a switch configuration. In another embodiment, the three power storage assemblies each operating at 220 volts may be configured in parallel (e.g., to charge at 220 volts), or two of the three may be configured in parallel, and then is connected to the third one in series (e.g., to charge at 220V and 240 volts). According to the present application, any suitable number of power storage assemblies (e.g., coupled to a switch configuration in series or in parallel) can be managed. It will be understood that the power storage assembly may include one or more submodules (e.g., individual submodules that may be coupled together to form a module).

### Alternative Embodiments

Embodiment 1. A method for constructing an exhaust channel for a power box, comprising the steps:
S1, providing a closed box body;
S2, providing an opening portion on the box body; and
S3, fixing a porous filter to the opening portion through a fastening member, and enclosing the opening portion.

2. The method according to embodiment 1, wherein at least one battery is accommodated in the power box and is capable of discharging gases; and the method further comprises the steps:
S4, constructing a fluid channel between the inside of the battery and the opening portion.

3. The method according to embodiment 2, wherein the step S4 further comprises the steps:
S41, covering an exhaust port of the at least one battery or an exhaust groove where the exhaust port is located through a gas collection cover;
S42, hermetically connecting the gas collection cover with the periphery of a notch of the exhaust groove or the exhaust port; and
S43, constructing a first section of the fluid channel between the opening portion and an exhaust vent/the exhaust port.

4. The method according to embodiment 3, wherein the step S43 further comprises the steps:
S431, enabling fluid communication between a) the opening portion and b) the exhaust vent/the exhaust port through an exhaust pipe;
S432, using a) a pipe fastener that fits a first end of the exhaust pipe and/or b) a hollow gas release member that fits a second end of the exhaust pipe to fix the exhaust pipe; and
S433, constructing a second section of the fluid channel between a gas outlet of the second end of the exhaust pipe and the opening portion.

5. The method according to embodiment 4, wherein the step S433 further comprises the steps:
S4331, inserting the second end of the exhaust pipe into a hollow chamber of the gas release member, thereby enabling the gas outlet to be in fluid communication with the porous filter or a surface of the porous filter through a gas release port of the gas release member;
S4332, shaping the porous filter into a hollow cylinder/hollow column, and fitting the porous filter with at least a portion of the gas release member in a sleeving manner;
S4333, protruding the opening portion corresponding to the porous filter to the outside of the box body and shaping into any of the following: a circular cylinder, a hollow cylinder, a cavity, a tubular cavity, or a finger ring shape; and
S4333, fixing the porous filter to the opening portion through a fastening member, and hermetically engaging the porous filter with the opening portion, so that the fastening member cooperates with the porous filter to enclose the opening portion.

6. The method according to embodiment 5, wherein the fastening member comprises a fixing cover, the porous filter is provided with a first port and a second port, and the first port and the second port are in communication through the inside of the porous filter; the step S4333 further comprises the step: closing the second port of the porous filter through the fixing cover, and pressing and fixing the first port on an open end face of the opening portion to hermetically connect the opening portion; and the method further comprises the steps:
S5, arranging a sealing member at one or more of the following places: a) between the porous filter and the fastening member, or b) between the porous filter and the opening portion, or c) between the fixing cover and the second port; or d) between an inner side of the opening portion and the gas collection cover; or e) between the opening portion and the gas release member; or f) between an inner wall of the opening portion and an outer pipe wall of the exhaust pipe; or g) between the first end of the exhaust pipe and the exhaust vent; and h) between the first end of the exhaust pipe and the pipe fastener;
S6, enabling a plurality of opposite walls of the box body to be concave inward to abut against/approach the battery, wherein the opposite walls comprise: i) a top wall, a bottom wall and/or ii) opposite side walls; and
S7: shaping the porous filter such that a maximum pore diameter/average pore diameter thereof is within any of the following intervals: [0.01 microns, 300 microns], [0.1 microns, 1.5 microns], [0.01 microns, 1 micron], [1 micron, 100 microns], [150 microns, 200 microns] or [100 microns, 180 microns], [0.05 microns, 150 microns], or [0.01 microns, 200 microns];
the enclosing is watertight covering or watertight enclosing;
the sealing member is an elastic member, the sealing member is made of an elastomer material, and
the sealing member is shaped into a gasket, a washer, or an O-ring;
the hermetical engagement is gas-tight coupling, and the gas-tight coupling is a gas-tight and liquid-tight threaded connection or chemical bounding; or
the engagement is a hermetical engagement, the hermetical engagement is a hermetical connection/hermetical sleeve fitting/hermetical sleeve connection and has liquid tightness and/or gas tightness, and the hermetical engagement comprises a threaded connection; or
the engagement has fluid communication;
the communication is fluid communication and/or hermetical communication;
the fluid communication is gas communication;
the gas inlet is in hermetical communication with the exhaust vent, and the filter closes the gas outlet, thereby forming the fluid channel, which provides a fluid-tight channel or a gas-tight channel between the exhaust vent and the filter, and provides a fluid channel by using the filter, which is in gas communication but not in liquid communication, between the inside and outside of the box body;
the watertightness of the filter is stronger than the gas tightness; the filter has gas permeability, and the filter does not have water permeability under the same temperature and/or pressure conditions;
the box body has a closed/sealed structure except the filter, or maintains watertightness and gas tightness; the filter has watertightness and no gas tightness; and
one or more of the batteries are lead-acid batteries that are capable of discharging gases.

7. A power box, comprising
a box body;
an opening portion, penetrating through a box wall of the box body;
a battery assembly, accommodated in the box body;
a porous filter, encapsulating the opening portion; and
a fastener,
wherein the porous filter is mounted to the opening portion through the fastener, and a maximum pore diameter/average pore diameter of the porous filter is within the following interval: [0.01 microns, 300 microns].

8. The power box according to embodiment 7, wherein
the fastener comprises a fastening member or a chemical bonding layer;
the fastening member cooperates with the porous filter to enclose the opening portion; and
the porous filter is made of a porous material, and a maximum pore diameter/average pore diameter thereof is within any of the following intervals: [0.1 microns, 1.5 microns], [0.01 microns, 1 micron], [1 micron, 100 microns], [150 microns, 200 microns] or [100 microns, 180 microns], [0.05 microns, 150 microns], or [0.01 microns, 250 microns].

9. The power box according to embodiment 8, wherein the fastening member further comprises a press fixing member and/or a connector; the press fixing member presses and fixes the porous filter on the box body; or
the connector and the press fixing member are connected to the box body; and the porous filter is clamped and fixed between the press fixing member and the box body.

10. The power box according to any one of claims 7 to 9, wherein
the porous filter corresponds to and/or fits the opening portion, and the porous filter is suitable for being engaged with the opening portion;
the porous filter is shaped into a cover body, and the porous filter fits the shape of the opening portion; and
the porous filter has a hollow structure, and the porous filter is shaped into any of the following: a circular cylinder, a hollow cylinder, a cavity, a tubular cavity, or a finger ring shape; or
the porous filter is provided with a first port, and the first port is connected to the opening portion.

11. The power box according to embodiment 10, wherein
a second positioning portion is arranged along the circumference of the opening portion, and the second positioning portion fits/corresponds to the first port; the first port is relatively fixed and/or connected to the opening portion through the second positioning portion; and/or,
the filter is further provided with a second portion opposite to the first port; the first port and the second port are in mutual communication other through the inside of the filter; the fixing cover is pressed and fixed on the second port and closes the second port; a first positioning portion is arranged on the periphery of an inner side of the fixing cover, and the first positioning portion fits/corresponds to the second port; and the fixing cover is relatively fixed to the second port through the first positioning portion, and the fixing cover closes the second port.

12. The power box according to embodiment 11, wherein
the first positioning portion is a groove or a step position, the first positioning portion is arranged on the inner side of the fixing cover along the circumference direction, and the first positioning portion clamps and fixes the second port; and/or
the second positioning portion is a groove or a step position, the second positioning portion is arranged along an end face of the opening portion, and the second positioning portion clamps and fixes the first port.

13. The power box according to embodiment 12, further comprising a gas release member, wherein the gas release member has a hollow structure, and the gas release member is provided with a gas vent and a mounting port;
the inside of the gas release member is in communication with the outside through the gas vent; or the gas vent and the mounting port are in fluid communication through the inside of the gas release member.

14. The power box according to embodiment 13, wherein the mounting port is engaged with the opening portion, and the mounting port is in fluid communication with the filter or an inner surface thereof through the inside of the gas release member and the gas vent;
the opening portion is shaped to protrude to the outside of the box body; the mounting port is provided in a first end of the gas release member, and the first end of the gas release member is in threaded connection with the opening portion;
the gas vent is provided in a second end of the gas release member, the gas vent is i) in fluid communication with the outside of the opening portion, or ii) exposed to the outside of the opening portion;
the press fixing member comprises a fixing cover, and the connector is a screw;
the fixing cover presses and fixes the filter on the opening portion; and
the screw passes through the fixing cover, and is in threaded connection with the second end of the gas release member.

15. The power box according to embodiment 14, further comprising an exhaust pipe, wherein the exhaust pipe is in communication with the exhaust vent and the gas release member, or the exhaust pipe is in fluid communication with the inside of the battery assembly and the gas release member;
a first end and a second end of the exhaust pipe separately define a gas inlet and a gas outlet;
the battery assembly is provided with an exhaust vent;
the gas inlet is in communication with the exhaust vent;
the mounting port is sleeved at the second end of the exhaust pipe, and the gas outlet is in fluid communication with the gas vent; or
the second end of the exhaust pipe is inserted into the gas release member from the mounting port, and the gas outlet is in fluid communication with the gas vent through the inside of the gas release member.

16. The power box according to embodiment 15, wherein
A) the battery assembly further comprises a housing, and the exhaust vent is provided in the housing; or
B) the battery assembly further comprises a housing, a gas collection cover, and one or more lead-acid batteries, wherein each lead-acid battery is provided with an exhaust port; the housing is partially concave to form an exhaust groove, and the exhaust ports in the one or more lead-acid batteries are all located in the exhaust groove; and
the gas collection cover covers the exhaust groove, the gas collection cover is connected to/hermetically connected to a notch of the exhaust groove, and the exhaust vents are provided in the gas collection cover.

17. The power box according to embodiment 16, wherein
the first end of the gas release member extends from the opening portion into the box body, and the first end of the gas release member is engaged with the second end of the exhaust pipe; the second end/gas vent of the gas release member is exposed to the outside of the opening portion;
the exhaust pipe is a flexible pipe, and the exhaust pipe is in flexible communication with the exhaust vent and the mounting port; and
the first end of the exhaust pipe is engaged with the exhaust vent.

18. The power box according to embodiment 17, further comprising a sealing member, wherein the sealing member is arranged between the opening portion and the gas release member;
the first end of the gas release member extends along the inner wall of the opening portion to the periphery of the opening portion, and an extended portion of the first end of the gas release member is clamped and fixed on the inner side of the opening portion through the sealing member.

19. The power box according to embodiment 13 or 14, wherein
the second end of the gas release member is integrally connected to the middle portion of the inner side of the fixing cover, the second end of the gas release member is perpendicular to the fixing cover, the second end of the gas release member extends to the opening portion, and the first end of the gas release member is in connection/sleeve fitting/sleeve connection/threaded connection with the opening portion;
the first end of the gas release member extends into the opening portion/the box body, and the mounting port is aligned with or in fluid communication with the exhaust vent; and
a protruding space of the opening portion is filled with a sealing member, the sealing member is located a) between the inner side of the opening portion and the gas collection cover; or b) between the inner side of the opening portion and the housing, and the scaling member surrounds i) the opening portion and ii) the exhaust vent.

20. The power box according to embodiment 16, further comprising:
a sealing member, wherein the sealing member is filled in the opening portion, and the sealing member is located between a) the inner wall of the opening portion and b) the outer pipe wall of the exhaust pipe.

21. The power box according to embodiment 16, wherein
the first end of the exhaust pipe is welded or chemically bound to the gas collection cover or the housing, and the gas inlet of the exhaust pipe is in communication/hermetical communication with the exhaust vent.

22. The power box according to embodiment 16, further comprising: a fixing connector and a sealing member,
wherein the first end of the exhaust pipe extends into the box body, and the first end of the exhaust pipe is engaged with the exhaust vent through the fixing connector; and
the sealing member is arranged between the first end of the exhaust pipe and the exhaust vent, and the sealing member surrounds the exhaust vent.

23. The power box according to embodiment 22, wherein the fixing connector further comprises:
a fixing member, wherein the fixing member is provided with a through hole, the fixing member is in fluid communication with and engaged with the exhaust vent; the fixing member is fixed on the gas collection cover or the housing; and
a pipe fastener, wherein the pipe fastener is separately connected to the fixing member and the first end of the exhaust pipe; the first end of the exhaust pipe and the fixing member clamp and fix the sealing member; the sealing member surrounds the through hole; and
the gas inlet is in fluid communication with the through hole.

24. The power box according to embodiment 23, wherein
the pipe fastener is provided with a first opening and a second opening opposite to each other, the first opening fits the fixing member in a sleeving manner, the second opening fits the first end of the exhaust pipe in a sleeving manner, the pipe fastener fastens and connects the fixing member with the first end of the exhaust pipe through the first opening and the second opening; and
the first opening and the second opening are in communication through the inside of the pipe fastener.

25. The power box according to embodiment 24, wherein
the first end of the exhaust pipe extends into the second opening; the second opening is contracted inward, or the first end of the exhaust pipe extends outward/to the periphery along the transverse direction, to be clamped into the second opening; and
the pipe fastener is in threaded connection with the fixing member, and the pipe fastener extrudes the first end of the exhaust pipe to the fixing member through the second opening.

26. The power box according to embodiment 25, further comprising a fluid channel, wherein the fluid channel is in communication with the inside of the battery assembly and the opening portion;
the covering/enclosing is watertight covering or watertight enclosing; an engaged portion/joint portion between the filter and the fastening member, or an engaged portion/join t portion between the filter and the opening portion has watertightness and/or gas tightness and/or tightness;
the screw passes through the fixing cover from the outside of the box body, the screw extends toward the opening portion, and the screw is in threaded connection with a screw hole in the gas release member,
the sealing member is an elastic member, the sealing member is made of an elastomer material, and the sealing member is shaped into a gasket, a washer, or an O-ring;
the sealing member is filled in the opening portion, and the sealing member is located between two or three of: a) the inner wall of the opening portion, b) the outer pipe wall of the exhaust pipe, and c) the second end of the exhaust pipe;
the gas collection cover hermetically covers the exhaust port, and a sealant is filled between the gas collection cover and the housing covered by the gas collection cover;
the hermetical engagement is gas-tight coupling, and the gas-tight coupling is a gas-tight and liquid-tight threaded connection or chemical bounding; or
the engagement is a hermetical engagement, the hermetical engagement is a hermetical connection/hermetical sleeve fitting/hermetical sleeve connection, the hermetical engagement has liquid tightness and/or gas tightness, and the hermetical engagement comprises a threaded connection; or
the engagement has fluid communication;
the communication is fluid communication and/or hermetical communication;
the fluid communication is gas communication;
the gas inlet is in hermetical communication with the exhaust vent, and the filter closes the gas outlet, thereby forming the fluid channel, which provides a fluid-tight channel or a gas-tight channel between the exhaust vent and the filter, and provides a fluid channel through the filter, which is in gas communication but not in liquid communication between the inside and outside of the box body;
the watertightness of the filter is stronger than the gas tightness; the filter has gas permeability, and the filter does not have water permeability under the same temperature and/or pressure conditions;
the box body has a closed/sealed structure except the filter, or maintains watertightness and gas tightness; the filter has watertightness and no gas tightness; and
the filter is a porous filter, and the interval of a maximum pore diameter/average pore diameter of the filter is: [0.05 microns, 150 microns], or [0.01 microns, 200 microns];
the transverse direction is perpendicular to the axial direction/length direction/extension direction of the exhaust pipe; and
a plurality of opposite walls of the box body are concave inward to abut against/approach the battery assembly, wherein the opposite walls comprise: i) a top wall, a bottom wall, and/or ii) opposite side walls.

In the description of the present disclosure, it should be understood that, the terms “center”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumference” and the like indicate orientations or positional relationships based on the orientations or positional relationships shown in the drawings, which are only for the convenience of describing the present disclosure and simplifying the description, rather than indicating or implying that the referred apparatuses or elements must have a specific orientation, be constructed and operated in a specific orientation, and therefore cannot be understood as a limitation on the present disclosure.

In the description of the present disclosure, “first feature” and “second feature” may include one or more such features.

In the description of the present disclosure, “a plurality of” means two or more.

In the description of the present disclosure, the first feature is “above” or “below” the second feature which may include direct contact between the first and second features, or may include that the first and second features are not in direct contact but through another feature contact between them.

In the description of the present invention, the first feature is “on” or “above” the second feature which includes that the first feature is directly above and obliquely above the second feature, or only indicates that the horizontal height of the first feature is higher than that of the second feature.

In the description of this specification, descriptions referring to the terms “one embodiment”, “some embodiments”, “exemplary embodiments”, “examples”, “specific example”, or “some examples” mean that specific features, structures, materials or characteristics described in connection with the embodiment(s) or example(s) are included in at least one embodiment or example of the present disclosure. In this specification, exemplary descriptions of the foregoing terms do not necessarily refer to the same embodiment or example. Furthermore, specific features, structures, materials, or characteristics described may be combined in any suitable manner in one or more embodiments or examples.

The filter element in some embodiments may be a filter element in a common water filtering apparatus, which has watertightness and no gas tightness, for example, has gas permeability but no water permeability at normal temperature and pressure. All the embodiments in this specification are described in a progressive way, and the same and similar parts among the embodiments can be referred to each other. All optional technical features can be combined with other embodiments in any reasonable way, and the contents among the embodiments and under various titles can also be combined in any reasonable way. Each embodiment focuses on the differences from other embodiments. In particular, for the system embodiment, since it is substantially similar to the method embodiment, the description is relatively simple. For the relevant parts, reference can be made to part of the description of the method embodiment.

The terms used in the embodiments of the present application is for the purpose of describing specific embodiments only and is not intended to limit the present application. The singular forms “a”, “said” and “the” used in the embodiments of the present application and the appended claims are also intended to include the plural forms, and “a plurality of” generally includes at least two unless the context clearly indicates other meanings. It should be understood that the term “and/or” used herein is only a description of the association relationship between associated objects, which means that there may be three relationships, for example, A and/or B may mean that A exists alone, A and B exist at the same time, and B exists alone. In addition, the character “/” herein generally means that front and rear associated objects are in an “or” relationship.

Although the specific embodiments of the present application have been described above, those skilled in the art should understand that this is only an example, and the scope of protection of the present application is defined by the appended claims. Those skilled in the art can make various changes or modifications to these implementation methods without departing from the principles and essence of the present application, but these changes and modifications fall within the scope of protection of the present application.

1. A method for construction an exhaust channel for a power box, comprising the steps:
S1, providing a closed box body;
S2, providing an opening portion on the box body; and
S3, fixing a porous filter to the opening portion through a fastening member, and enclosing the opening portion.

2. The method according to claim 1, wherein at least one battery assembly is accommodated in the power box, the battery assembly is capable of discharging gases, and the method further comprises the step:
S4, constructing a fluid channel between the inside of the battery assembly and the opening portion.

3. The method according to claim 2, wherein the step S4 further comprises the steps:
S41, covering an exhaust vent/exhaust port of the at least one battery assembly or an exhaust groove where the exhaust vent/exhaust port is located through a gas collection cover;
S42, hermetically connecting the gas collection cover with the periphery of a notch of the exhaust groove or the exhaust vent/exhaust port; and
S43, constructing a first section of the fluid channel between the opening portion and the exhaust vent/the exhaust port.

4. The method according to claim 3, wherein the step S43 further comprises the steps:
S431, enabling fluid communication between a) the opening portion and b) the exhaust vent/the exhaust port through an exhaust pipe;
S432, using a) a pipe fastener that fits a first end of the exhaust pipe and/or b) a hollow gas release member that fits a second end of the exhaust pipe to fix the exhaust pipe; and
S433, constructing a second section of the fluid channel between a gas outlet of the second end of the exhaust pipe and the opening portion.

5. The method according to claim 4, wherein the step S433 further comprises the steps:
S4331, inserting the second end of the exhaust pipe into a hollow chamber of the gas release member, thereby enabling the gas outlet to be in fluid communication with the porous filter or a surface of the porous filter through a gas release port of the gas release member;
S4332, shaping the porous filter into a hollow cylinder/hollow column, and fitting the porous filter with at least a portion of the gas release member in a sleeving manner;
S4333, protruding the opening portion corresponding to the porous filter to the outside of the box body and shaping into any of the following: a circular cylinder, a hollow cylinder, a cavity, a tubular cavity, or a finger ring shape; and
S4333, fixing the porous filter to the opening portion through the fastening member, and engaging the porous filter with the opening portion, so that the fastening member cooperates with the porous filter to enclose the opening portion.

6. The method according to claim 5, wherein the fastening member comprises a fixing cover, the porous filter is provided with a first port and a second port, and the first port and the second port are in communication through the inside of the porous filter; the step S4333 further comprises the step:
closing the second port of the porous filter through the fixing cover, and pressing and fixing the first port on an open end face of the opening portion to hermetically connect the opening portion; and the method further comprises the steps:
S5, arranging a sealing member at one or more of the following places: a) between the porous filter and the fastening member, or b) between the porous filter and the opening portion, or c) between the fixing cover and the second port; or d) between an inner side of the opening portion and the gas collection cover; or e) between the opening portion and the gas release member; or f) between an inner wall of the opening portion and an outer pipe wall of the exhaust pipe; or g) between the first end of the exhaust pipe and the exhaust vent; and h) between the first end of the exhaust pipe and the pipe fastener;
S6, enabling a plurality of opposite walls of the box body to be concave inward to abut against/approach the battery assembly, wherein the opposite walls comprise: i) a top wall, a bottom wall and/or ii) opposite side walls; and
S7, shaping the porous filter such that a maximum pore diameter/average pore diameter of the porous filter is within any of the following intervals: [0.01 microns, 300 microns], [0.1 microns, 1.5 microns], [0.01 microns, 1 micron], [1 micron, 100 microns], [150 microns, 200 microns] or [100 microns, 180 microns], [0.05 microns, 150 microns], or [0.01 microns, 200 microns], wherein
the enclosing is watertight covering or watertight enclosing;
the sealing member is an elastic member, the sealing member is made of an elastomer material, and the sealing member is shaped into a gasket, a washer or an O-ring;
the engagement is gas-tight coupling, and the gas-tight coupling is a gas-tight and liquid-tight threaded connection or chemical bonding; or
the engagement is a hermetical engagement, the hermetical engagement is a hermetical connection/hermetical sleeve fitting/hermetical sleeve connection, the hermetical engagement has liquid tightness and/or gas tightness, and the hermetical engagement comprises a threaded connection; or
the engagement has fluid communication;
the communication is fluid communication and/or hermetical communication;
the fluid communication is gas communication;
a gas inlet is in hermetical communication with the exhaust vent, and the porous filter closes the gas outlet, thereby forming the fluid channel, which provides a fluid-tight channel or a gas-tight channel between the exhaust vent and the porous filter, and provides a fluid channel by using the porous filter, which is in gas communication but not in liquid communication, between the inside and outside of the box body;
the watertightness of the porous filter is stronger than the gas tightness; the porous filter is gas permeable, and the porous filter is not gas permeable under the same temperature and/or pressure conditions;
the box body has a closed/sealed structure except the filter, or maintains watertightness and gas tightness; the porous filter has watertightness and no gas tightness; and
the at least one battery are lead-acid batteries that are capable of discharging gases.

7. A power box, comprising
a box body;
an opening portion, penetrating through a box wall of the box body;
a battery assembly, accommodated in the box body;
a porous filter, encapsulating the opening portion; and
a fastener,
wherein the porous filter is mounted to the opening portion through the fastener, and a maximum pore diameter/average pore diameter of the porous filter is within the following interval: [0.01 microns, 300 microns].

8. The power box according to claim 7, wherein
the fastener comprises a fastening member or a chemical bonding layer;
the fastening member cooperates with the porous filter to enclose the opening portion; and
the porous filter is made of a porous material, and a maximum pore diameter/average pore diameter of the porous filter is within any of the following intervals: [0.1 microns, 1.5 microns], [0.01 microns, 1 micron], [1 micron, 100 microns], [150 microns, 200 microns] or [100 microns, 180 microns], [0.05 microns, 150 microns], or [0.01 microns, 250 microns].

9. The power box according to claim 8, wherein the fastening member further comprises a press fixing member and/or a connector; the press fixing member presses and fixes the porous filter on the box body; or
the connector and the press fixing member are connected to the box body; and the porous filter is clamped and fixed between the press fixing member and the box body.

10. The power box according to claim 7, wherein
the porous filter corresponds to and/or fits the opening portion, and the porous filter is suitable for being engaged with the opening portion;
the porous filter is shaped into a cover body, and the porous filter fits the shape of the opening portion; and
the porous filter has a hollow structure, and the porous filter is shaped into any of the following: a circular cylinder, a hollow cylinder, a cavity, a tubular cavity, or a finger ring shape; or
the porous filter is provided with a first port, and the first port is connected to the opening portion.

11. The power box according to claim 10, wherein
a second positioning portion is arranged along the circumference of the opening portion, and the second positioning portion fits/corresponds to the first port; the first port is relatively fixed and/or connected to the opening portion through the second positioning portion; and/or,
the filter is further provided with a second portion opposite to the first port; the first port and the second port are in mutual communication other through the inside of the filter; the fixing cover is pressed and fixed on the second port and closes the second port; a first positioning portion is arranged on the periphery of an inner side of the fixing cover, and the first positioning portion fits/corresponds to the second port; and the fixing cover is relatively fixed to the second port through the first positioning portion, and the fixing cover closes the second port.

12. The power box according to claim 11, wherein
the first positioning portion is a groove or a step position, the first positioning portion is arranged on the inner side of the fixing cover along the circumference direction, and the first positioning portion clamps and fixes the second port; and/or
the second positioning portion is a groove or a step position, the second positioning portion is arranged along an end face of the opening portion, and the second positioning portion clamps and fixes the first port.

13. The power box according to claim 12, further comprising a gas release member, wherein the gas release member has a hollow structure, and the gas release member is provided with a gas vent and a mounting port;
the inside of the gas release member is in communication with the outside through the gas vent;
or the gas vent and the mounting port are in fluid communication through the inside of the gas release member.

14. The power box according to claim 13, wherein the mounting port is engaged with the opening portion, and the mounting port is in fluid communication with the filter or an inner surface thereof through the inside of the gas release member and the gas vent;
the opening portion is shaped to protrude to the outside of the box body; the mounting port is provided in a first end of the gas release member, and the first end of the gas release member is in threaded connection with the opening portion;
the gas vent is provided in a second end of the gas release member, the gas vent is i) in fluid communication with the outside of the opening portion, or ii) exposed to the outside of the opening portion;
the press fixing member comprises a fixing cover, and the connector is a screw;
the fixing cover presses and fixes the filter on the opening portion; and
the screw passes through the fixing cover, and is in threaded connection with the second end of the gas release member.

15. The power box according to claim 14, further comprising an exhaust pipe, wherein the exhaust pipe is in communication with an exhaust vent and the gas release member, or the exhaust pipe is in fluid communication with the inside of the battery assembly and the gas release member;
a first end and a second end of the exhaust pipe separately define a gas inlet and a gas outlet;
the battery assembly is provided with an exhaust vent;
the gas inlet is in communication with the exhaust vent;
the mounting port is sleeved at the second end of the exhaust pipe, and the gas outlet is in fluid communication with the gas vent; or
the second end of the exhaust pipe is inserted into the gas release member from the mounting port, and the gas outlet is in fluid communication with the gas vent through the inside of the gas release member.

16. The power box according to claim 15, wherein
A) the battery assembly further comprises a housing, and the exhaust vent is provided in the housing; or
B) the battery assembly further comprises a housing, a gas collection cover, and one or more lead-acid batteries, wherein each lead-acid battery is provided with an exhaust port; the housing is partially concave to form an exhaust groove, and the exhaust ports in the one or more lead-acid batteries are all located in the exhaust groove; and
the gas collection cover covers the exhaust groove, the gas collection cover is connected to/hermetically connected to a notch of the exhaust groove, and the exhaust vents are provided in the gas collection cover.

17. The power box according to claim 16, wherein
the first end of the gas release member extends from the opening portion into the box body, and the first end of the gas release member is engaged with the second end of the exhaust pipe; the second end/gas vent of the gas release member is exposed to the outside of the opening portion;
the exhaust pipe is a flexible pipe, and the exhaust pipe is in flexible communication with the exhaust vent and the mounting port; and
the first end of the exhaust pipe is engaged with the exhaust vent.

18. The power box according to claim 17, further comprising a sealing member, wherein the sealing member is arranged between the opening portion and the gas release member;
the first end of the gas release member extends along the inner wall of the opening portion to the periphery of the opening portion, and an extended portion of the first end of the gas release member is clamped and fixed on the inner side of the opening portion through the sealing member.

19. The power box according to claim 14, wherein
the second end of the gas release member is integrally connected to the middle portion of the inner side of the fixing cover, the second end of the gas release member is perpendicular to the fixing cover, the second end of the gas release member extends to the opening portion, and the first end of the gas release member is in connection/sleeve fitting/sleeve connection/threaded connection with the opening portion;
the first end of the gas release member extends into the opening portion/the box body, and the mounting port is aligned with or in fluid communication with the exhaust vent; and
a protruding space of the opening portion is filled with a sealing member, the sealing member is located a) between the inner side of the opening portion and the gas collection cover; or b) between the inner side of the opening portion and the housing, and the sealing member surrounds i) the opening portion and ii) the exhaust vent.

20. The power box according to claim 16, further comprising:
a sealing member, wherein the sealing member is filled in the opening portion, and the sealing member is located between a) the inner wall of the opening portion and b) the outer pipe wall of the exhaust pipe.

21. The power box according to claim 16, wherein
the first end of the exhaust pipe is welded or chemically bound to the gas collection cover or the housing, and the gas inlet of the exhaust pipe is in communication/hermetical communication with the exhaust vent.

22. The power box according to claim 16, further comprising: a fixing connector and a sealing member,
wherein the first end of the exhaust pipe extends into the box body, and the first end of the exhaust pipe is engaged with the exhaust vent through the fixing connector; and
the sealing member is arranged between the first end of the exhaust pipe and the exhaust vent, and the sealing member surrounds the exhaust vent.

23. The power box according to claim 22, wherein the fixing connector further comprises:
a fixing member, wherein the fixing member is provided with a through hole, the fixing member is in fluid communication with and engaged with the exhaust vent; the fixing member is fixed on the gas collection cover or the housing; and
a pipe fastener, wherein the pipe fastener is separately connected to the fixing member and the first end of the exhaust pipe; the first end of the exhaust pipe and the fixing member clamp and fix the sealing member; the sealing member surrounds the through hole; and
the gas inlet is in fluid communication with the through hole.

24. The power box according to claim 23, wherein
the pipe fastener is provided with a first opening and a second opening opposite to each other, the first opening fits the fixing member in a sleeving manner, the second opening fits the first end of the exhaust pipe in a sleeving manner, the pipe fastener fastens and connects the fixing member with the first end of the exhaust pipe through the first opening and the second opening; and
the first opening and the second opening are in communication through the inside of the pipe fastener.

25. The power box according to claim 24, wherein
the first end of the exhaust pipe extends into the second opening; the second opening is contracted inward, or the first end of the exhaust pipe extends outward/to the periphery along the transverse direction, to be clamped into the second opening; and
the pipe fastener is in threaded connection with the fixing member, and the pipe fastener extrudes the first end of the exhaust pipe to the fixing member through the second opening.

26. The power box according to claim 25, further comprising a fluid channel, wherein the fluid channel is in communication with the inside of the battery assembly and the opening portion;
the covering/enclosing is watertight covering or watertight enclosing; an engaged portion/joint portion between the filter and the fastening member, or an engaged portion/join t portion between the filter and the opening portion has watertightness and/or gas tightness and/or tightness;
the screw passes through the fixing cover from the outside of the box body, the screw extends toward the opening portion, and the screw is in threaded connection with a screw hole in the gas release member,
the sealing member is an elastic member, the sealing member is made of an elastomer material, and the sealing member is shaped into a gasket, a washer, or an O-ring;
the sealing member is filled in the opening portion, and the sealing member is located between two or three of: a) the inner wall of the opening portion, b) the outer pipe wall of the exhaust pipe, and c) the second end of the exhaust pipe;
the gas collection cover hermetically covers the exhaust port, and a sealant is filled between the gas collection cover and the housing covered by the gas collection cover;
the engagement is gas-tight coupling, and the gas-tight coupling is a gas-tight and liquid-tight threaded connection or chemical bonding; or
the engagement is a hermetical engagement, the hermetical engagement is a hermetical connection/hermetical sleeve fitting/hermetical sleeve connection, the hermetical engagement has liquid tightness and/or gas tightness, and the hermetical engagement comprises a threaded connection; or
the engagement has fluid communication;
the communication is fluid communication and/or hermetical communication;
the fluid communication is gas communication;
the gas inlet is in hermetical communication with the exhaust vent, and the filter closes the gas outlet, thereby forming the fluid channel, which provides a fluid-tight channel or a gas-tight channel between the exhaust vent and the filter, and provides a fluid channel through the filter, which is in gas communication but not in liquid communication between the inside and outside of the box body;
the watertightness of the filter is stronger than the gas tightness; the filter has gas permeability, and the filter does not have water permeability under the same temperature and/or pressure conditions;
the box body has a closed/sealed structure except the filter, or maintains watertightness and gas tightness; the filter has watertightness and no gas tightness;
the filter is a porous filter, and the interval of a maximum pore diameter/average pore diameter of the filter is: [0.05 microns, 150 microns], or [0.01 microns, 200 microns];
the transverse direction is perpendicular to the axial direction/length direction/extension direction of the exhaust pipe; and
a plurality of opposite walls of the box body are concave inward to abut against/approach the battery assembly, wherein the opposite walls comprise: i) a top wall, a bottom wall, and/or ii) opposite side walls.
